(19) United States
(12) Patent Application Publication
(10) Pub. No.: US 2003/0232112 A1
(43) Pub. Date: Dec. 18, 2003

(54) Packaging system assembly for carry-out food

(76) Inventors: Rebecca E. Whitmore, Chilton, WI (US); Kathleen R. Rigotti, Neenah, WI (US); Debra D. Bowers, Menasha, WI (US)

Correspondence Address: Michael W. Ferrell, Esq., Ferrells, PLLC, P.O. Box 312, Clifton, VA, 20124-1706, US

(21) Appl. No.: 10/456,744

(22) Filed: Jun. 6, 2003

Related U.S. Application Data
(60) Provisional application No. 60/389,331, filed on Jun. 17, 2002.

(51) Int. Cl. A23B 4/00

(52) U.S. Cl. 426/108

(57) ABSTRACT

A packaging system assembly for carry-out food includes (a) a plurality of sealable and stackable disposable containers; and (b) a multilayer composite carry-out bag which is preferably substantially water vapor and liquid-impervious provided with an apertured handle and at least front, back and preferably bottom panels, said carry-out bag further including a mechanical interlock for securing the front panel thereof to the rear panel thereof in generally water vapor impermeable relationship. The bottom panel is preferably substantially congruent in shape to the sealable and stackable disposable containers and is characterized by an internal perimeter sized to accommodate a stack of the plurality of sealable containers having a common outer container perimeter to form the packaging system assembly and maintain the stack in alignment during transport thereof.

### CLAIM FOR PRIORITY

This non-provisional application claims the benefit of the filing date of U.S. Provisional Patent Application Serial No. 60/389,331, of the same title, filed Jun. 17, 2002.

### TECHNICAL FIELD

The present invention relates generally to packaging for carry-out foods. In a preferred embodiment, the packaging system assembly includes a heat-retaining sealable composite bag and a plurality of stackable and microwaveable containers and is characterized by horizontal stability when suspended from its handle or placed on a flat surface.

### BACKGROUND

Carry-out food is often provided in ordinary shopping bags and food containers which may or may not include stacking features. Ordinary bags tend to have relatively high aspect ratios at their bottoms, for example, a typical bag may have an 8×12 flat bottom with an aspect ratio of 1.5. The food containers, on the other hand, may be round or square having an aspect ratio of 1 or an oval shape with an aspect ratio of 1.4 or less. A high aspect ratio bag thus does not support a stack of containers and maintain them in horizontal stacking relationship, often promoting leakage and spillage from the containers if and when their lids separate from their bases.

Moreover, typical conventional bags employed are single layer and do not have means for sealing them, nor are they adapted to insulate the contents so as to maintain their temperature or provide for ease in handling. Some packaging employs metallized layers which are reported to aid in heat retention. See, U.S. patent application Ser. No. 09/910,203, Publication No. US2003/0017243, Jan. 23, 2003, and note that metallized film is not generally self-supporting. So also, ordinary bags tend to lack the strength necessary to transport a significant load when the bag is grasped by an apertured handle or a handle attached to the bag. This deficiency is ameliorated somewhat by using heavy gauge plastic and/or special handle designs and/or by using nonwoven fabrics such as Tyvek® spunbond polyethylene and so forth. See, for example: U.S. Pat. No. 3,948,436 to Bambera disclosing a multilayer bag provided with a spunbond fabric layer; U.S. Pat. No. 5,127,536 to Cohen et al. disclosing a shopping bag which may be made of spunbond polyethylene; as well as U.S. Pat. Nos. 5,346,708 and 5,576,037 relating to heavy gauge shrink wrap bags for frozen turkeys. These containers are relatively expensive and difficult to fabricate as compared with mass-produced ordinary shopping bags and may be unsuitable or prohibitively expensive for carry-out food packaging.

Conventional food containers, particularly disposable food containers, tend to be lightweight and prone to crushing when even moderate force is applied to their lids; again, leading to spillage and leakage.

It is accordingly an object of the invention to provide a carry-out food packaging system with a carry-out bag sized to accommodate food containers and maintain them in stable stacked alignment during transport.

It is a further object to provide a liquid-impervious heat-retaining bag provided with a handle for secure and convenient transport adapted for maintaining the assembly in horizontal orientation when suspended therefrom.

A still further object of the invention is to provide a carry-out food packaging system with conveniently lidded, crush-resistant sealable food containers.

These and other features of the invention are discussed below.

### SUMMARY OF INVENTION

A packaging system assembly for carry-out food includes: (a) a plurality of sealable and stackable disposable containers each of which includes a lid and a base, the lids including ridge means about their upper portion adapted to receive the base of a like container and maintain the like container in aligned stacked relationship thereto when the containers are stacked, each of the plurality of containers being characterized by a common outer container perimeter; and (b) a multilayer composite carry-out bag which is substantially water vapor and liquid-impervious provided with an apertured handle and at least front, back and bottom panels, the carry-out bag further including a mechanical interlock for securing the front panel thereof to the rear panel thereof in generally liquid and water vapor impermeable relationship. The bottom panel is substantially congruent in shape to the sealable and stackable disposable containers and is characterized by an internal perimeter sized to accommodate a stack of the plurality of sealable containers having the common outer container perimeter to form the packaging system assembly and maintain the stack in alignment during transport thereof. As is seen in the accompanying Figures, the assembly is configured to maintain the disposable containers horizontally while suspended from its apertured handle; is capable of being stably disposed on a horizontal flat surface while suspended from the apertured handle while maintaining the disposable containers horizontally and may be removed from the horizontal flat surface by the apertured handle while maintaining the disposable containers horizontally.

Preferably, the carry-out bag is provided with a generally flat bottom panel provided with an aspect ratio of about 1.4 or less; typically, the flat bottom panel has an aspect ratio of about 1.3 or less. In some cases, the front panel of the carry-out bag is joined directly to the rear panel of the carry-out bag, for example, the front panel of the carry-out bag may be melt-bonded to the rear panel of the carry-out bag.

In preferred embodiments, the carry-out bag includes as one layer a metallized polymer film and as another layer a paper layer. The carry-out bag may be thus formed from a laminated composite material incorporating a metallized polymer film, a second polymer film laminated thereto and a paper layer which is likewise laminated to the second polymer film. Most preferably, the paper layer of the carry-out bag is pattern laminated to the metallized polymer film, optionally including one or more intermediate polymer layers.

In preferred embodiments the handle may be any handle with an open portion to accommodate the hand of a consumer, such as a loop of fabric or cord secured to the front and back panels or a plastic handle secured to the top of the bag. In some cases, an apertured handle of the carry-out bag is die-cut into the front and back panels of the carry-out bag. This may be accomplished wherein the die-cut handle is configured such that the panel material is cut over less than a complete handle aperture perimeter whereby the material of the panels may be folded through the handle aperture to provide a mechanical interlock in order to secure the front panel to the rear panel. The apertured handle may have an arched upper grip if so desired and generally exhibit an Instron® failure value of at least about 20 lbs. Instron® failure values of 30 lbs. or even 40 lbs. minimum are preferred in most cases. Desirably reinforcing material is provided around the opening for added security.

Likewise, the carry-out bag is preferably made of a self-supporting laminated material which will maintain the handle in an erect position available for grasping.

Preferably, the front and back panels of the carry-out bag are provided with mating interior closure elements about their upper portions in the interior of the carry-out bag to secure the front panel of the carry-out bag to the back panel of the carry-out bag upon application of pressure to the closure elements. The mating closure elements typically include a first continuous closure element extending substantially entirely across the interior of the front panel of the carry-out bag and a second continuous closure element extending substantially entirely across the interior of the entire back panel of the carry-out bag which are adapted to form a substantially liquid-proof and vapor-proof seal upon application of pressure to the closure elements so as to seal the interior of the carry-out bag. The first and second continuous closure elements preferably comprise male and female closure elements arranged to be interlocked over their length, of the type typically used in connection with Ziploc® brand plastic bags.

Generally speaking, the internal perimeter of the carry-out bag is from about 5 to about 30 percent larger than the common outer container perimeter of the plurality of sealable disposable containers; and preferably the internal perimeter of the carry-out bag is from about 7.5 to about 25 percent larger than the common outer container perimeter of the plurality of sealable disposable containers. In some cases, the internal perimeter of the carry-out bag is from about 10 to about 20 percent larger than the common outer container perimeter of the plurality of sealable disposable containers.

The bag laminate material typically consists of an outer paper ply, ranging in basis weight from 10 to 50 lbs/ream, extrusion laminated using a quilted bonding pattern as shown in the Figures with 5-12 lbs/ream LDPE to metallized polymer film. The bag may be a stand up pouch. This structure requires an inner ply that can be heat sealed to form the bag. This can be accomplished either by using a heat sealable film such as LDPE, or a film with a heat seal coating, such as PP (polypropylene) or PET (polyethylene terephthalate). The stand up pouch can be fitted with a plastic “zipper” closure. Die cut handle openings can be cut into the top above the zipper. Alternatively, a part of the handle opening can be cut out, leaving top flaps that fold over and help close the bag, eliminating the need for the zipper. Alternatively, a flat bottom bag with rectangle cross-section bottom may be used. This bag can be made on conventional bag making equipment, using a glue compatible with the film inner ply. This type of bag must be rectangular rather than square in cross-section to from side gussets without interference from opposite sides, and to die cut a handle with a closing flap after the bag is formed, because the gussets intrude into the center handle location. As another alternative, there could be provided a satchel bag. The bag bottom cross-section can be either square or rectangular. The side gussets are folded out rather than inward, making a wide bag when it lies flat, and the gussets do not interfere with a die cut handle. Because the gussets are folded out, they will not interfere with each other during forming and the bottom cross-section can be square.

In preferred embodiments, the container base of the food containers is made of a microwaveable material and the lid of the food container is configured to be crush-resistant as described hereinafter. Likewise, the food containers can be provided with interchangeable lid-base portions to reduce necessary components in the inventive system.

Further features and advantages of the present invention will become apparent from the description which follows.

### BRIEF DESCRIPTION OF DRAWINGS

The invention is described in detail below in connection with the various Figures wherein like numerals designate similar parts and wherein:

FIG. 1 is a schematic view in perspective and partial cutaway of the inventive carry-out food packaging system assembly;

FIG. 1A is a partial view in elevation of an alternate configuration of a carry-out bag;

FIG. 1B is a partial view in elevation of another configuration of a carry-out bag;

FIG. 1C is a partial view in elevation of the bag of FIG. 1;

FIG. 2 is a schematic plan view illustrating the perimeter of a stack of food containers inside of the carry-out bag of the invention;

FIG. 3 is a schematic view in perspective illustrating the shape of the bottom panel of the bag of FIG. 1;

FIG. 4 is a schematic exploded view of a composite material useful for forming the bag of FIG. 1;

FIG. 5 is a schematic view in section of a pattern laminated composite of the material shown in FIG. 4;

FIG. 6A is a schematic cross-section of closure elements fitted to the bag of FIG. 1 about the upper portion of the front panels of the bag of FIG. 1;

FIG. 6B is a schematic cross-section of alternate closure elements which may be fitted to the bag of FIG. 1;

FIG. 7 is a view in perspective of a disposable lid having 50 flutes;

FIG. 8 is a sectional plan view of the periphery of the sidewall of the lid of FIG. 7 along line 8-8;

FIG. 9 is a sectional schematic view in elevation of the lid profile from center along the centerline of a flute of the lid of FIG. 7 at line 9-9;

FIG. 10 is a sectional schematic view in elevation of the lid profile from center along an unfluted portion of the lid of FIG. 7 at line 10-10;

FIG. 11 is a schematic view comparing the profiles of a fluted portion (FIG. 9) and unfluted portion (FIG. 10) of the disposable lid of FIG. 7;

FIG. 12 is a sectional schematic view in elevation along line 12-12 of FIG. 7, showing the profile of the removal tab;

FIG. 13 is a schematic view illustrating the profile of a stepped lid;

FIG. 14 is an exploded view in perspective showing a serving base member and sealing lid;

FIG. 15 is a top view of the container of FIG. 14 wherein the sealing lid has been affixed to the serving base member;

FIG. 16 is a schematic detail along line 16-16 of FIG. 14 showing the geometry of the inventive sealing lid;

FIG. 17 is a schematic view along line 17-17 of FIG. 14 illustrating the profile of the inventive sealing lid along the centerline of a flute;

FIG. 18 is a schematic view along line 18-18 of FIG. 14 showing the profile of the flat portion of the sealing lid between the flutes in the sidewall of the lid of the containers;

FIG. 19 is a schematic view comparing the profile of the flat portions between flutes and the outwardly convex flutes about the periphery of a sealing lid;

FIG. 20 is an enlarged schematic detail illustrating the cooperation of a base serving member and a sealing lid to secure the lid and base to one another and provide a sealed interior; and preferably, a substantially liquid proof seal;

FIG. 21 is a schematic diagram illustrating the cooperation of stacking features to provide a secure stack of containers;

FIG. 22 is an exploded view in perspective of yet another sealable food container useful in connection with the present invention;

FIG. 23 is a schematic view showing the profile from center of a bowl forming a base of the container of FIG. 22;

FIG. 24 is an enlarged schematic view showing a portion of a planar lid secured to the sidewall of a container base; and

FIGS. 25-30 illustrate yet another class of stackable containers having interchangeable parts useful in connection with the present invention.

### DETAILED DESCRIPTION

The invention is described in detail below with reference to the various Figures. Such description is for purposes of illustration, only. Modifications to specific embodiments within the spirit and scope of the present invention, set forth in the appended claims, will be readily apparent to those of skill in the art.

As used herein, terminology is given its ordinary meaning unless specifically otherwise defined. “Mils”, for example, refers to thousandths of an inch; caliper to wall thickness and “characteristic diameter” to the overall diameter of a container or a portion thereof as will be apparent from the container. That is to say, the characteristic diameter of a container base is the diameter across the outermost portion of the article for a generally circular article such as a bowl or plate. For other shapes, an average diameter may be used. Throughout this specification and claims, the term “dome” and its derivatives are used in the broad sense of a vault, ceiling, cover or roof having an inner surface which is generally concave regardless of whether the inner surface is hemispherical, polyhedral or another compound shape.

A particularly preferred material for a disposable container base is mica-filled polypropylene, optionally provided with calcium carbonate, polyethylene and titanium dioxide in suitable amounts as hereinafter described. A sealing lid may be a planar paperboard lid or polymeric lid as described hereinafter. A paperboard lid may be coated with a filled or pigmented composition as is well known in the art. Alternatively, other suitable materials for the lid include laminates to paperboard or polymer substrates, for instance, foils laminated to paperboard.

The containers useful in connection with the invention are made by any suitable technique, typically, techniques employed for forming plastics. The products may thus be made from thermoplastic sheet which has been pre-cut or in the form of a continuous web or roll formed, thermoformed, thermoformed by the application of vacuum or thermoformed by a combination of vacuum and pressure into the products of the invention. Alternatively, the inventive containers may be made from a plastic material by injection molding, injection blow molding, compression molding, injection stretch molding, composite injection molding and so forth. Thermoforming from plastic sheet is particularly preferred.

In the simplest form, thermoforming is the draping of a softened sheet over a shaped mold. In the more advanced form, thermoforming is the automatic high speed positioning of a sheet having an accurately controlled temperature into a pneumatically actuated forming station whereby the article's shape is defined by the mold, followed by trimming and regrind collection as is well known in the art. Still other alternative arrangements include the use of drape, vacuum, pressure, free blowing, matched die, billow drape, vacuum snap-back, billow vacuum, plug assist vacuum, reverse draw with plug assist, pressure bubble immersion, trapped sheet, slip, diaphragm, twin-sheet cut sheet, twin-sheet roll-fed forming or any suitable combinations of the above. Details are provided in J. L. Throne's book, Thermoforming, published in 1987 by Coulthard. Pages 21 through 29 of that book are incorporated herein by reference. Suitable alternate arrangements also include a pillow forming technique which creates a positive air pressure between two heat softened sheets to inflate them against a clamped male/female mold system to produce a hollow product. Metal molds are etched with patterns ranging from fine to coarse in order to simulate a natural or grain-like texturized look. Suitable formed articles are trimmed in line with a cutting die and regrind is optionally reused since the material is thermoplastic in nature. Other arrangements for productivity enhancements include the simultaneous forming of multiple articles with multiple dies in order to maximize throughput and minimize scrap.

A particularly preferred material for a plate or platter is mica-filled polypropylene, optionally provided with calcium carbonate, polyethylene and titanium dioxide in suitable amounts as hereinafter described. The sealing lid or cover may be opaque or transparent and is made of a transparent styrene polymer composition in some cases. Typically, the lid is oriented or rubberized to give it sufficient rigidity and flexibility to provide a good seal. As will be appreciated by one of skill in the art, suitable polymeric materials for the disposable plate and cover are readily available. Mineral filled polypropylene, especially mica filled polypropylene is, for example, suitable for the base as noted above. Other suitable flexible and resilient materials include other polyolefins such as polyethylenes, polypropylenes and mixtures and copolymers thereof, polyesters, polyamides, polyacrylates, polystyrenes, polysulfones, polyether ketones, polycarbonates, acrylics, polyphenylene sulfides, acetals, cellulosics, polyetherimides, polyphenylene ethers/oxides, styrene maleic anhydride copolymers, styrene acrylonitrile coploymers, polyvinylchlorides, and engineered resin derivatives thereof. These materials may be filled or unfilled, solid (continuous) or foamed.

A platter, bowl or plate of a food container used in the system of the present invention may be produced utilizing polymeric compositions filled with conventional inorganic fillers such as talc, mica, wollastonite and the like, wherein the polymer component is, for example, a polyester, a polystyrene homopolymer or copolymer, a polyolefin or one or more of the polymers noted above. While any suitable polymer may be used, polypropylene polymers which are suitable for the plate, bowl or platter are preferably selected from the group consisting of isotactic polypropylene, and copolymers of propylene and ethylene wherein the ethylene moiety is less than about 10% of the units making up the polymer, and mixtures thereof. Generally, such polymers have a melt flow index from about 0.3 to about 4, but most preferably the polymer is isotactic polypropylene with a melt-flow index of about 1.5. In some preferred embodiments, the melt-compounded composition from which the articles are made may include polypropylene and optionally further includes a polyethylene component and titanium dioxide. A polyethylene polymer or component may be any suitable polyethylene such as HDPE, LDPE, MDPE, LLDPE or mixtures thereof and may be melt-blended with polypropylene if so desired.

The various polyethylene polymers referred to herein are described at length in the Encyclopedia of Polymer Science & Engineering (2d Ed.), Vol. 6; pp: 383-522, Wiley 1986; the disclosure of which is incorporated herein by reference. HDPE refers to high density polyethylene which is substantially linear and has a density of generally greater that 0.94 up to about 0.97 g/cc. LDPE refers to low density polyethylene which is characterized by relatively long chain branching and a density of about 0.912 to about 0.925 g/cc. LLDPE or linear low density polyethylene is characterized by short chain branching and a density of from about 0.92 to about 0.94 g/cc. Finally, intermediate density polyethylene (MDPE) is characterized by relatively low branching and a density of from about 0.925 to about 0.94 g/cc.

Typically, in filled plastics useful for making the plate or container base of the food container the primary mineral filler is mica, talc, kaolin, bentonite, wollastonite, milled glass fiber, glass beads (solid or hollow), silica, or silicon carbide whiskers or mixtures thereof. We have discovered that polypropylene may be melt-compounded with acidic-type minerals such as mica, as well as inorganic materials and/or basic materials such as calcium carbonate. Other fillers include talc, barium sulfate, calcium sulfate, magnesium sulfate, clays, glass, dolomite, alumina, ceramics, calcium carbonate, silica, pigments such as titanium dioxide based pigments and so on. Many of these materials are enumerated in the Encyclopedia of Materials Science and Engineering, Vol. #3, pp. 1745-1759, MIT Press, Cambridge, Mass. (1986), the disclosure of which is incorporated herein by reference. Combinations of fillers are preferred in some embodiments.

Mineral fillers are sometimes referred to by their chemical names. Kaolins, for example, are hydrous alumino silicates, while feldspar is an anhydrous alkalialumino silicate. Bentonite is usually an aluminum silicate clay and talc is hydrated magnesium silicate. Glass, or fillers based on silicon dioxide may be natural or synthetic silicas. Wollastonite is a calcium metasilicate whereas mica is a potassium alumino silicate. Clays may be employed as a primary filler; the two most common of which are kaolin and bentonite. Kaolin refers generally to minerals including kaolinite which is a hydrated aluminum silicate (Al₂O₃.2SiO₂.2H₂O) and is the major clay mineral component in the rock kaolin. Kaolin is also a group name for the minerals kaolinite, macrite, dickite and halloysite. Bentonite refers to hydrated sodium, calcium, iron, magnesium, and aluminum silicates known as montmorillonites which are also sometimes referred to as smectites.

Fillers commonly include: barium salt; barium ferrite; barium sulfate; carbon/coke powder; calcium fluoride; calcium sulfate; carbon black; calcium carbonate; ceramic powder; chopped glass; clay; continuous glass; glass bead; glass fiber; glass fabric; glass flake; glass mat; graphite powder; glass sphere; glass tape; milled glass; mica; molybdenum disulfide; silica; short glass; talc; whisker. Particulate fillers, besides mica, commonly include: glass; calcium carbonate; alumina; beryllium oxide; magnesium carbonate; titanium dioxide; zinc oxide; zirconia; hydrated alumina; antimony oxide; silica; silicates; barium ferrite; barium sulphate; molybdenum disulfide; silicon carbide; potassium titanate; clays. Fibrous fillers are commonly: whiskers; glass; mineral wool; calcium sulphate; potassium titanate; boron; alumina; sodium aluminum hydroxy carbonate.

As noted above, a mica-filled polypropylene polymer composition is particularly preferred for forming the base or plate portion of the container.

A dome portion of a container useful in the packaging system of the present invention may be formed of any of the materials described above, and is perhaps most preferably formed from an oriented or rubberized polystyrene composition, optically transparent materials being preferred in many cases. The lid or dome may be thermoformed from biaxially oriented polystyrene sheet (OPS) or can include polystyrene and a blended rubber component or may be a styrene/rubber copolymer such as K resin. K resin is a copolymer of styrene and butadiene and is available from Phillips Petroleum, Bartlesville, Oklahoma. Preferred grades included from about 2 to about 40 wt. % butadiene. Alternatively or in addition to diene comonomer, the styrene compositions may contain one or more of the rubbery polymers discussed below.

So-called core-shell polymers built up from a rubber-like core on which one or more shells have been grafted may be used. The core usually consists substantially of an acrylate rubber or a butadiene rubber. One or more shells have been grafted on the core. Usually these shells are built up for the greater part from a vinylaromatic compound and/or a vinylcyanide and/or an alkyl(meth)acrylate and/or (meth)acrylic acid. The core and/or the shell(s) often comprise multi-functional compounds which may act as a cross-linking agent and/or as a grafting agent. These polymers are usually prepared in several stages.

Olefin-containing copolymers such as olefin acrylates and olefin diene terpolymers can also be used as rubbery modifiers in the present compositions. An example of an olefin acrylate copolymer modifier is ethylene ethylacrylate copolymer available from Union Carbide as DPD-6169. Other higher olefin monomers can be employed as copolymers with alkyl acrylates, for example, propylene and n-butyl acrylate. The olefin diene terpolymers are well known in the art and generally fall into the EPDM (ethylene propylene diene) family of terpolymers. They are commercially available such as, for example, EPSYN 704 from Copolymer Rubber Company. They are more fully described in U.S. Pat. No. 4,559,388, incorporated by reference herein.

Various rubber polymers and copolymers as such can also be employed as modifiers. Examples of such rubbery polymers are polybutadiene, polyisoprene, and various other polymers or copolymers having a rubbery olefinic monomer.

Styrene-containing rubbery polymers are also suitable modifiers. Examples of such polymers are acrylonitrile-butadiene-styrene, styrene-acrylonitrile, acrylonitrile-butadiene-alpha-methylstyrene, styrene-butadiene, styrene butadiene styrene, diethylene butadiene styrene, methacrylate-butadiene-styrene, high rubber graft ABS, and other high impact styrene-containing polymers such as, for example, high impact polystyrene. Other known impact modifiers include various elastomeric materials such as organic silicone rubbers, elastomeric fluorohydrocarbons, elastomeric polyesters, the random block polysiloxane-polycarbonate copolymers, and the like. The preferred organopolysiloxane-polycarbonate block copolymers are the dimethylsiloxane-polycarbonate block copolymers in some embodiments.

Suitable sealable containers may have any particular size and shape as desired so long as the relative base and lid features are present. More specifically, square or rectangular with rounded corners, triangular, oval, multi-sided, polyhedral, and similar shapes may be made having the profile described above including plates, bowls, platters, and common lidding features such as 6-1/16-inch and 12 oz., 7-5/16-inch and 20 oz. plates and bowls. In various embodiments of the present invention the container may be 6-1/16-inch, 7-5/16-inch, 9-inch, 10-¼-inch and 11-inch plates and so forth. The container may include a compartmented base in the form of a plate of the class described in co-pending U.S. patent application Ser. No. 09/354,706, filed Jul. 16, 1999, entitled “Compartmented Disposable Plate With Asymmetric Rib Geometry”, (Attorney Docket No. 2195; FJ-99-10), now U.S. Pat. No. 6,440,509, issued Aug. 27, 2002.

It is especially preferred in some cases that the container bases are made of a readily microwaveable material such as a material which includes polypropylene, polyester, and/or polyethylene. Polypropylene and polyethylene terephthalate (PET) are preferred; particularly crystalline PET when PET is utilized.

The following co-pending United States Patent Applications provide further illustration as to containers:

U.S. patent application Ser. No. 09/921,264, filed Aug. 2, 2001, entitled “Disposable Serving Plate With Sidewall-Engaged Sealing Cover” of M. B. Littlejohn et al. (Attorney Docket No. 2242; FJ-00-32), now U.S. Pat. No.______ ;

U.S. Provisional Application Serial No. 60/305,225, filed Jul. 13, 2001, entitled “Crush-Resistant Disposable Lid”, of G. J. Van Handel et al. (Attorney Docket No. 2366; GP-01-15), now U.S. Pat. No.______;

U.S. patent application Ser. No. 10/068,924, filed Feb. 8, 2002, entitled “A Sealable Food Container With Improved Lidding and

Stacking Features”, of M. B. Littlejohn et al. (Attorney Docket No. 2390; GP-01-33), now U.S. Pat. No.______;

U.S. patent application Ser. No. 10/151,558, filed May 20, 2002, entitled “A Sealable Food Container with Sidewall Lid Retaining Shelf” of M. B. Littlejohn et al. (Attorney Docket No. 2390-1; GP-01-33-1), now U.S. Pat. No.______;

U.S. patent application Ser. No. 10/151,632, filed May 20, 2002, entitled “Food Container with Interchangeable Lid—Base Seal Design”, which was based upon U.S. Provisional Application No. 60/293,796, of the same title, filed May 25, 1001, now U.S. Pat. No.______; and

United States Provisional Application No. 60/441,960 filed Jan. 23, 2003, entitled “Food Container With Interchangeable Lid—Base Seal Provided with Radially and Circumferentially Undercut Sealing Profile, Asymmetric Interlocking Stacking Ridges and Improved Separator Tab”.

As to composite materials for forming the carry-out bag, the following issued United States Patents are noted:

U.S. Pat. No. 5,480,693, issued Jan. 2, 1996, entitled “Composite Integral Sheet of Highly Absorbent Wrap Material With Hydrophobic Water-Vapor-Permeable Pellicle”, of R. Patterson et al.; and

U.S. Pat. No. 5,582,674, issued Dec. 10, 1996, entitled “Composite Integral Sheet of Highly Absorbent Wrap Material With Hydrophobic Water-Vapor-Permeable Pellicle and Method of Making Same”, of R. Patterson et al.

Further, preferred closure elements useful for incorporating into the bags of the invention are generally described in the following issued United States Patents:

U.S. Pat. No. 4,907,321, issued Mar. 13, 1990, entitled “Enhanced Color Change Interlocking Closure Strip”, of J. W. Williams; and

U.S. Pat. No. 4,829,641, issued May 16, 1989, entitled “Enhanced Color Change Interlocking Closure Strip”, of J. W. Williams.

The disclosure of the foregoing patents and co-pending patent applications is incorporated herein by reference.

As used throughout the specification and claims, terminology is given its ordinary meaning as supplemented or further described herein. Thus, a “self-supporting material” is one which will support its own weight and remain erect when so positioned. A bag reliably transports a given load when it will repeatedly lift and support that load without tearing or otherwise failing. A “die cut” handle is cut into the material forming the bag with a suitable die to form an aperture operative as a handle and so forth.

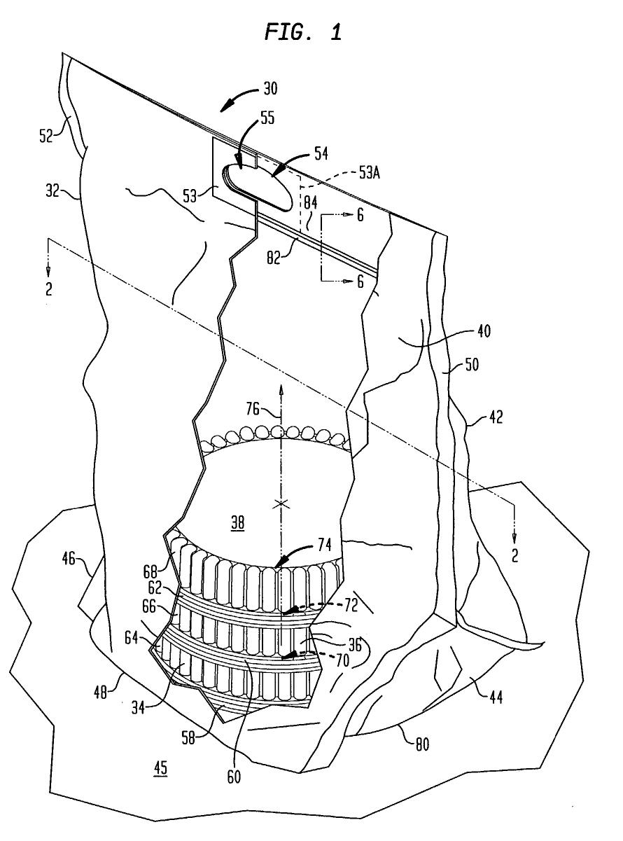

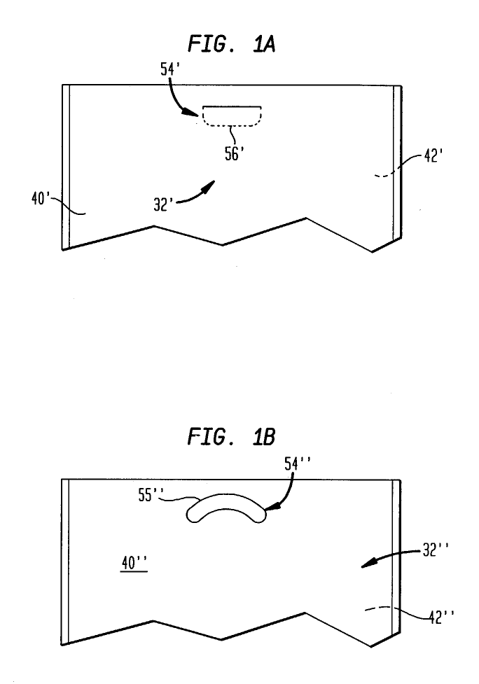

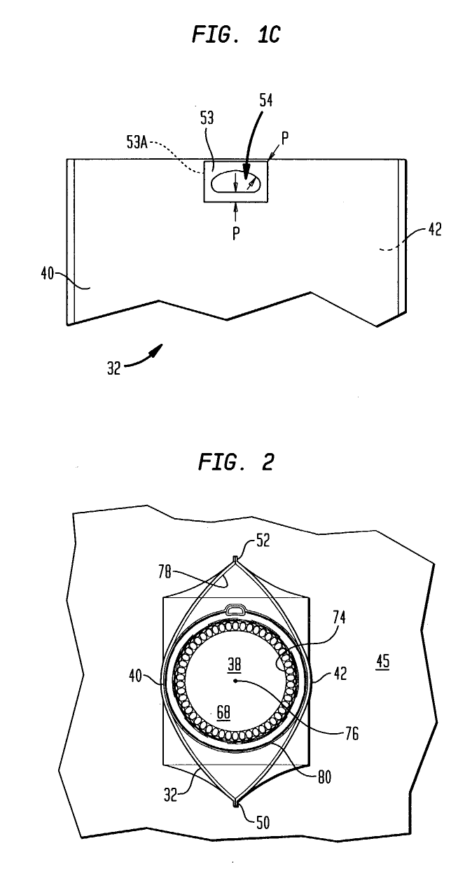

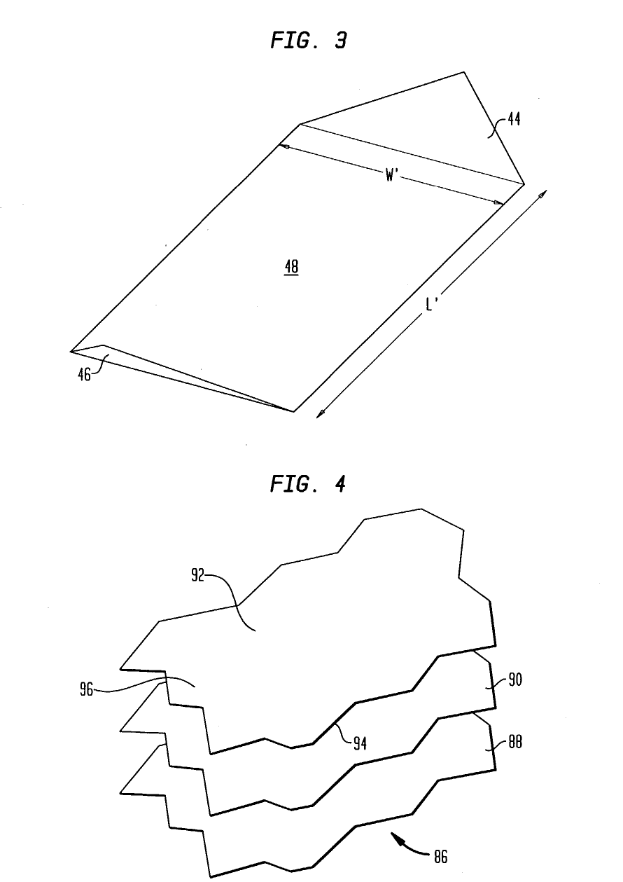

Turning to the Figures, there is shown in FIGS. 1-3 the invention carry-out food packaging system 30 including a compact bag 32 and a plurality of containers 34, 36, 38. Bag 32 has a front panel 40, a back panel 42 and a pair of gussets 44, 46 transitioning from a generally flat, planar bottom panel 48 to the sides of bag 32. Bag 32 is thus a stand-up pouch type of bag which is known in the art.

Front panel 40 is heat-bonded to back panel 42 along a pair of melt-bonded seams 50, 52. Alternatively, the bag could be assembled with any suitable adhesive. Panels 40 and 42 are provided with a die-cut handle 54 which may have the cut material removed as shown in FIG. 1 or may have the material left in as shown in FIG. 1A wherein a handle 54′ also serves to interlock front panel 40′ with back panel 42′ of bag 32′ when folded through the aperture indicated at 56′.

The handle on the carry-out bag should be configured such that it will reliably transport and will not fail while transporting a load of 3 lbs; more preferably, such that it will not fail under a load of at least 5 lbs, and still more preferably such that the bag will reliably transport a load of at least about 7 lbs. Preferred handles will support more of a load as measured by an Instron® tester since the force is applied slowly. In order to initially assess the strength of various designs, a variety of panel materials were provided with die-cut aperture handles which were round, rounded rectangular, or arched in shape. Also, a rigid handle was fabricated externally and attached to a panel. Two of the samples were provided with die-cut handles which were cut only around the lower portion of the aperture periphery as shown in FIG. 1A and folded over. Individual panels were coupled via their handles to an Instron® tensile tester by way of U-shaped coupling elements, secured and tested for failure under load. A cross-head speed of 5 inches per minute was used. Failure force was recorded for five duplicate panels. Details are given in Table 1 which also reports the handle (2 panel) Instron® values (2×1 panel failure force).

TABLE 1
Instron ® Failure Force for Die-Cut Handles

| | | | | | | 40 lb. | 50 lb. | 40 lb. | 50 lb. |
|---|---|---|---|---|---|---|---|---|---|
| | 1 mil | | | | | Kraft/70 | Kraft/70 | Kraft, | White, |
| | HDPE | 3 mil | | | | gauge PP | gauge PP | Round | Rounded |
| | Film, | HDPE, | 0.75 | 20 mil | 1.5 mil | Laminate, | Laminate, | Rectangle, | Rectangle, |
| | Round | Rounded | HDPE, | HDPE, | LDPE, | Rounded | Rounded | Material | Material |
| Description | Shape | Rectangle | Arch | Rigid | Round | Rectangle | Rectangle | In | In |
| 1 panel | 13.5 | 18 | 17 | 20 | 10 | 11 | 11 | 29 | 29 |
| force (lbs.) | | | | | | | | | |
| 2 panel | 28 | 37 | 34 | 40 | 20 | 22 | 22 | 58 | 58 |
| force (lbs.) | | | | | | | | | |

The reinforced “material in” or folded over handles (FIG. 1A) provided very high failure values, as did the arched shape, considering the relatively lightweight material from which the test panel was made. The arched shape panel is generally as shown schematically in FIG. 1B. In FIG. 1B there is shown a carry-out bag 32″ provided with a front panel 40″ and a rear panel 42″. Here, both panels have a die-cut handle 54″ provided with an arched upper grip portion 55″.

In many cases, it will be desirable to add reinforcing panels around the cut-outs forming the apertured handle so that a lighter overall weight can be used for the carry-out bag while retaining sufficient strength. Conveniently this can be, done by laminating a generally rectangular panel of a high strength material such as air laid nonwoven fabrics such as, for example, Tyvek® spunbond fabric to the handle area while providing a cut-out conforming to the cut-out in the carry-out bag as is shown in FIG. 1 and FIG. 1C.

A preferred reinforced handle construction as is shown generally in FIG. 1 is shown in more detail in FIG. 1C wherein a pair of substantially identical reinforcing panels 53, 53A are adhered to front and rear panels 40, 42, respectively. The panels extend outwardly from the handle aperture perimeter a distance, P, which may vary over the perimeter of the handle and which distance is typically from about ¼ inch to about 2 inches. The reinforcing panels are preferably fibrous reinforcing panels. A particularly preferred fibrous reinforcing panel is made from nonwoven polymer fabric or film such as spunbond polyethylene fibers such as Tyvek® spunbond polyethylene. The panels may be adhered by any suitable adhesive such as a pressure-sensitive adhesive as is seen, for example, in U.S. Pat. No. 6,423,932 to Koch et al., the disclosure of which is incorporated herein by reference.

Following the Instron® testing procedure described generally above, apertured bag panels having various designs (with and without reinforcing panels) were tested for handle strength as set forth in Table 2. It is seen in Table 2 that fibrous reinforcing panels greatly increase apertured handle strength.

TABLE 2
Instron ® Failure Force for Apertured Handles

| | Average Max Force, |
|---|---|
| | one bag panel |
| Description | with handle |
| 1.0 mil HDPE Round | 13.4 |
| 3.0 mil HDPE Round Rectangle | 17.9 |
| 0.75 mil HDPE Arch | 17.1 |
| 2.0 mil HDPE Rigid handle | 20.3 |
| 1.5 mil LDPE Round | 10.0 |
| 40# Kraft, 70-gauge OPP Round Rectangle | 10.7 |
| 50# White, 70-gauge OPP Round Rectangle | 11.2 |
| 40# Kraft, plastic reinforcement patch. | 29.9 |
| Round Rectangle Material In | |
| 50# White Kraft, plastic reinforcement patch. | 28.8 |
| Round Rectangle Material In | |
| 30# Bleached Kraft, 70-gauge MOPP, modified | 12.6 |
| arch handle 3 × 1.5 inches, similar to production | |
| shape | |
| 30# Bleached Kraft, 70-gauge MOPP, modified | 29.0 |
| arch handle 3 × 1.5 inches, similar to production | |
| shape, reinforced with Tyvek ® patch | |
| Production bag with zipper - 1 panel: | 20.2 |
| 30#Bleached Kraft, 70-gauge MOPP, modified | |
| arch handle 3 × 1.5 inches, similar to production | |
| shape, reinforced with Tyvek ® patch | |
| Production bag with zipper: - both panels | 34.3* |
| complete bag | |
| 30# Bleached Kraft, 70-gauge MOPP, modified | |
| arch handle 3 × 1.5 inches, similar to production | |
| shape, reinforced with Tyvek ® patch | |

*2 panel maximum force

The carry-out bag is preferably constructed such that the apertured handle of the carry-out bag will be maintained in an erect position when the packaging system assembly is placed on a flat surface such that the upper grip indicated at 55 of the handle is maintained generally in a raised position as shown in FIG. 1. This is accomplished typically by using a suitably stiff material for the front and rear panels so that the upper portion of the carry-out bag is at least self-supporting and will preferably support the weight of a handle other than a die-cut handle when the handle is fabricated separately and attached to the bag. Paper/polymer film laminates are preferred in this regard.

Containers 34, 36 and 38 are generally provided with container base portions 58, 60 and 62 as well as their associated lids 64, 66 and 68 as shown in FIG. 1. Lids 64-68 include on their upper portions retaining or stacking ridges 70, 72 and 74 which are adapted to engage the bottom of container base portions such as the base portions of containers 58, 60 and 62 so as to maintain them in stacked relationship to one another as shown in FIGS. 1, 2, 21 and 30. The location of stacking ridges 70, 72 are indicated generally by dotted lines only; they are identical in configuration to stacking ridge 74 at the top of the stack. Preferably, the contours of the containers are all arranged on a stack axis 76 and maintained in this configuration during transport.

The stack is maintained in alignment by the ridges on the tops of the containers (or suitable flange/flat lid designs as discussed hereinafter) as well as by bag 32.

In this respect, bag 32 has an internal perimeter 78 which is matched to, but slightly larger than, perimeter 80 of containers 34, 36 and 38. The containers preferably all have a common perimeter as shown with a round shape being one preferred embodiment. For 9″ containers the width, W, of bag 32 may be as little as 15-16 inches, but more preferably is about 19-20 inches to allow room for users to inert their hands past the containers for convenient removal and loading.

A preferred embodiment of the inventive packaging assembly includes a plurality of 10½″ containers fitted with sealing lids. The assembly may be sized with a carry-out bag internal perimeter of 40″ or so to allow for a 20%-25% clearance (diameter basis) around the containers. In order to size the bag for 4 stacked containers having a height of 2½″ each a typical bag height, H, would allow for 10″ of containers, plus another 8 or 9 inches to allow for sealing the bag. The carry-out bag would thus suitably have a height of about 18-19 inches for 4 containers and a height of at least about 15½-16½ inches when sized for 3 such containers.

Bottom panel 48 is generally planar and generally of “low aspect” ratio (that is, squarish) wherein the ratio L′/W′ is less than about 1.4, and may be a square (aspect ratio of 1) if so desired. The flat bottom is adjacent gussets 44 and 46 which extend to seams 50 and 52, respectively. Note that the assembly is stable on horizontal surface 45, may be stably placed thereon and lifted by way of the handle. If so desired, a bag with a round bottom panel could be used.

There are additionally provided in a preferred embodiment a pair of internal closure elements indicated at 82, 84 which serve to secure front panel 40 to rear panel 42. Preferably, the elements are continuous closure elements which extend entirely across the panels as shown so that the carry-out bag may be sealed to retain heat or maintain the contents at a desired temperature. In this respect, bag 32 is preferably made as a quilt-laminated composite material including at least 3 layers as is shown in FIG. 4.

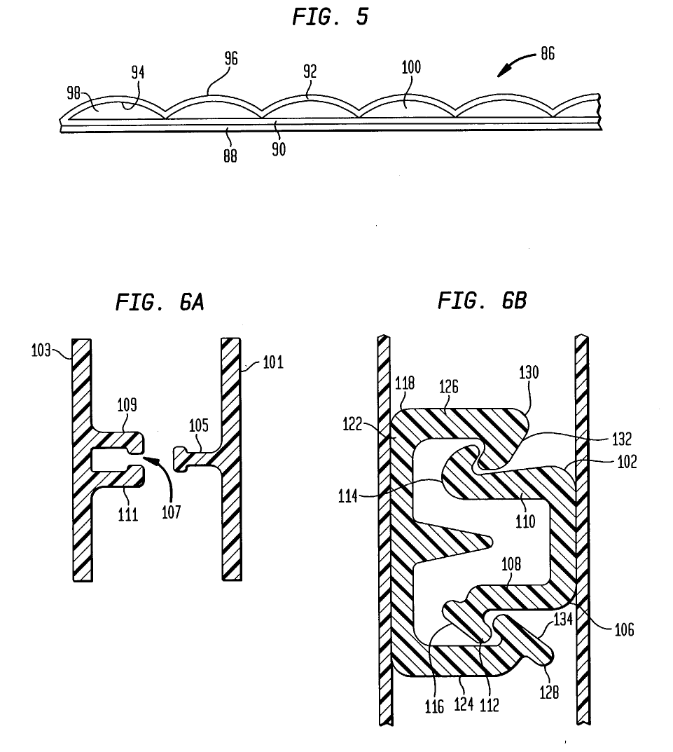

Composite bag material 86 shown in FIGS. 4 and 5 includes an outer paper layer 88 laminated to an LDPE layer 90, which in turn is laminated to a polypropylene film layer 92. LDPE layer 90 is continuously laminated to paper layer 88. The paper layer provides for fold retention and structural rigidity as well as being a preferred printing substrate.

Polypropylene layer 92 most preferably includes a metallized surface 94 which is pattern laminated to LDPE layer 90. Metallized surface 94 may be vapor deposited aluminum or other metal to provide for enhanced internal heat retention. Pattern or quilt lamination is preferred since it provides further for insulative air pockets indicated at 98, 100 on FIG. 5.

Inner surface 96 of polypropylene layer 92 is typically provided with either a heat sealable coating or layer so that seams 50, 52 can be formed of the material.

A particularly preferred method of sealing bag 32 is to provide continuous sealing elements of the class used in connection with Ziploc® plastic bags. There is shown FIGS. 6A and 6B cross-sections of suitable elements at 82, 84 from FIG. 1.

In FIG. 6A there is shown a male element 101 and a female element 103 which are arranged, typically secured with an adhesive on opposed internal surfaces of the bag. Element 101 has a sealing projection 105, while element 103 defines a groove 107 by way of a pair of projections 109, 111. Projection 105 fits tightly into groove 107 between projections 109, 111 to seal the bag by virtue of their interlocking geometry. Alternatively, more sophisticated closure elements can be employed as is seen in FIG. 6B.

FIG. 6B shows an embodiment wherein a male element portion 102 is connected to a flange portion 104 and includes a base portion 106, a pair of spaced-apart, first webs 108 and 110 extending in a generally normal direction from the base portion 106, and male hook portions 112 and 114 extending from webs 108 and 110, respectively, and facing away from each other. One of the male hook portions has an inwardly projecting guide surface 116, which generally serves to guide the hook portions for occlusion with the female hook portions of a mating closure element. A female element portion 118 includes a base portion 122, a pair of spaced-apart, parallely disposed webs 124 and 126 extending in a generally normal direction from base portion 122 and female hook portions 128 and 130 extending from webs 124 and 126, respectively, and facing towards each other. One of the female hook portions has a rounded crown surface 132, the other has an inwardly projecting guide surface 134 which serves to guide the hook portions for occlusion with the male hook portions of a mating closure element. Closure elements 102 and 118, shown in FIG. 6B may be separately formed and then connected to a film which forms sidewalls of a bag body, or they may be integrally formed with such sidewalls.

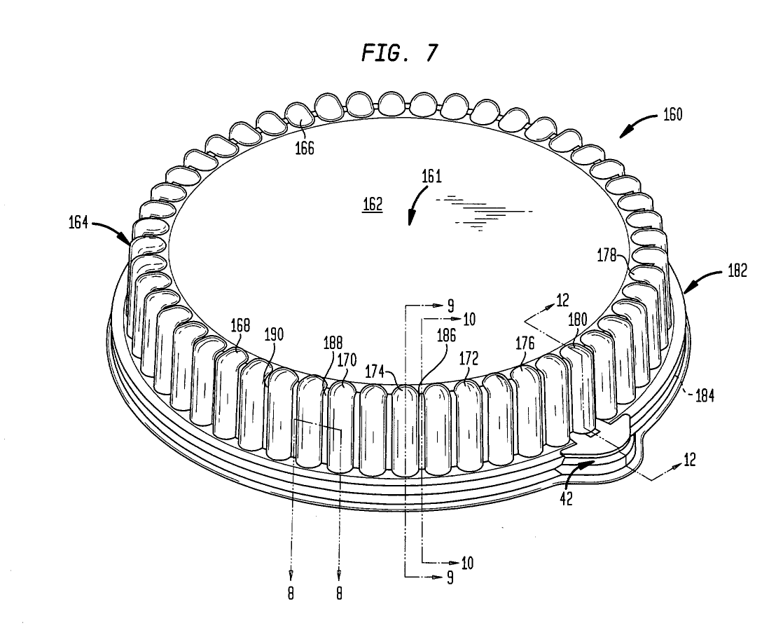

Referring to FIGS. 7 through 12, there is illustrated a crush-resistant disposable lid 160 made from a thermoplastic material for plates, platters, bowls and the like including a dome portion 161 with a generally planar upper surface portion 162 and a downwardly extending sidewall 164 provided with a plurality of outwardly convex flutes such as flutes 166-180 formed in the sidewall with a characteristic cylindrical diameter. The sidewall extends downwardly to an engagement portion 182 of the lid adapted to be secured to a plate, platter or bowl about an engagement perimeter 184 of the lid. Typically, the lid includes about 1.85 or fewer flutes per inch of engagement perimeter; suitably from about 1.5 to about 1.85 flutes per inch of engagement perimeter, with from about 1.6 to about 1.75 flutes per inch of engagement perimeter being preferred in some embodiments. The lid illustrated in FIG. 7 has about 1.7 flutes per inch of engagement perimeter; that is 50 flutes about 30 inches for a 9½″ diameter plate, for example.

Inventive lid 160 has unfluted sidewall portions such as portions 186-190 between flutes 166-180. It is not necessary to add fillets transitioning between the fluted and unfluted portions of the sidewall with the inventive design as will be appreciated from the deflection data which follows. There is further provided a stepped removal tab 192 which is used to disengage the lid from a plate.

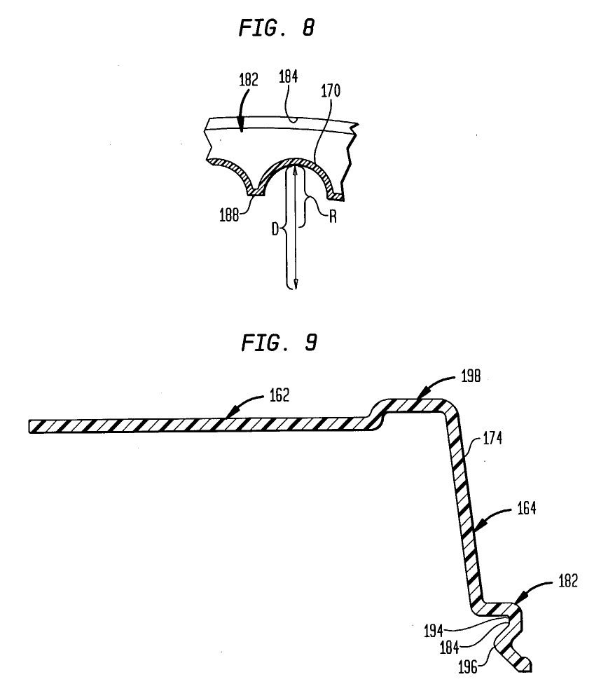

The geometry of the sidewall is better appreciated by reference to FIG. 8 which is a plan view in section along line 8-8 of FIG. 7. Flute 170 is shaped as a partial surface of an inclined outwardly convex cylinder (convex about its outer surface), which may be inclined 10°, 15° or so with respect to a perpendicular upper surface portion 162 of dome 161 or the upper surface of engagement portion 182; that is, a 10° or 15° sidewall angle. The cylinder has a characteristic radius which is the radius of curvature, R, of flute 170. Thus, the flute may be said to have a characteristic cylindrical diameter, D, of twice the radius of curvature of the flute. In the embodiment shown, the flutes have the same characteristic cylindrical diameter; however, there may be flutes of other configuration interspersed without departing from the spirit and scope of the invention.

The various features of the profile of the lid are perhaps best illustrated in FIGS. 9, 10 and 11. The sidewall extends downwardly to engagement portion 182 about the perimeter of the lid which includes an undercut groove 194 provided with an undercut portion 196. Undercut groove 194 extends about substantially the entire periphery of lid 160 (except at tab 192) so as to form a continuous seal when engaged to a plate, platter, bowl or the like by way of its undercut portion 196. Groove 194 thus defines at its outer wall the engagement perimeter 184 which has a length of about 30 inches or so when configured for a 9½″ diameter plate as in FIG. 7.

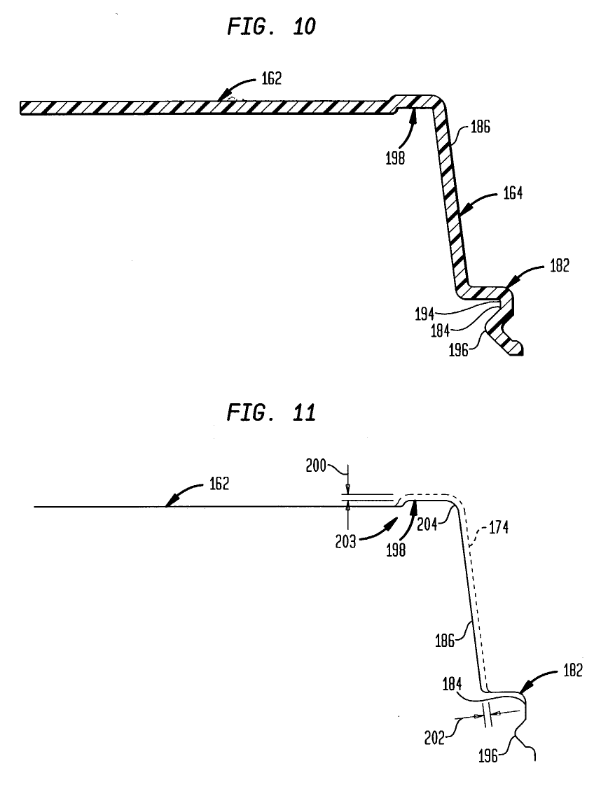

FIG. 9 is a view in section and elevation along line 9-9 in FIG. 7 showing the profile of lid 160 from center along the center of flute 174; whereas, FIG. 10 is a view in section and elevation showing unfluted portion 186 of sidewall 164. FIG. 11 is a schematic diagram illustrating the relative dimensions of the profiles of FIGS. 9 and 10. Along the central area of the dome portion 161, the profiles are substantially identical, whereas at outer portion 198, the fluted portion 174 is shown in a dashed line and unfluted portion 186 is shown in a solid line. The unfluted areas are slightly raised at 198, whereas the flutes have a substantial height. At the engagement periphery, the profiles are again identical. Fluted portion 174 projects upwardly a distance 200 at the top portion with respect to unfluted portion 186 and outwardly a distance 202 with respect to the unfluted sidewall as shown in FIG. 11. This distance is referred to herein as the flute height. So also, fluted portion 174 has an inward extension length as shown at 203, which is generally the maximum inward distance from corner 204 that a flute 174 is raised above the unfluted portion of dome 161.

The flutes may have a characteristic cylindrical diameter of from about 0.4 inches to about 0.6 inches in the embodiment of FIG. 7, preferably about 0.5 inches. The ratio of the characteristic cylindrical diameter of the flutes to the engagement perimeter of said lid is typically at least about 0.0125, and preferably the ratio of the characteristic cylindrical diameter of the flutes to the engagement perimeter of said lid is from about 0.0125 to about 0.025. In the embodiment of FIG. 7, the ratio of the characteristic cylindrical diameter of the flutes to the engagement perimeter of the lid is about 0.018.

The inward extension length of the flutes may be at least about 0.35 inches and is sometimes at least about 0.5 inches. The ratio of the inward extension length of the flutes to the engagement perimeter may be from about 0.015 to about 0.04. In the embodiment of FIG. 7, the ratio of the inward extension length of the flutes to the engagement perimeter is about 0.02.

Generally, the lid has a wall caliper of from about 8 to about 20 mils, preferably from about 8 to about 15 mils, and more preferably from about 10 to about 13 mils. In some embodiments, the lid is thermoformed by the application of vacuum. Typical materials include oriented polystyrene sheet and thermoplastic materials comprising polypropylene.

In preferred embodiments, the engagement portion of the lid includes an undercut groove such as groove 194 extending substantially continuously about the engagement perimeter.

In typical lids of the invention, the flutes have a flute height of greater than about 0.075 inches, preferably from about 0.075 to about 0.125 inches.

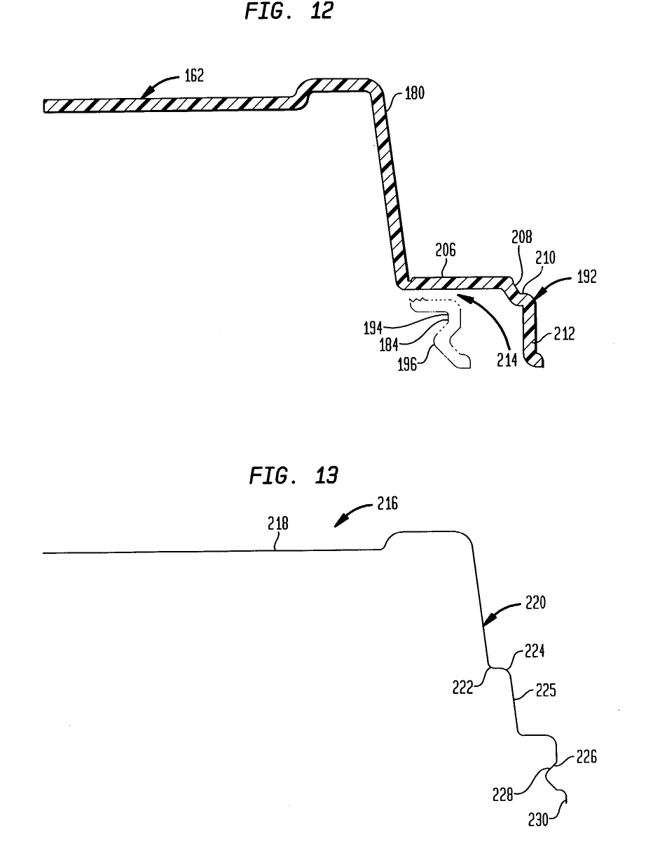

Lid 160 includes a removal tab 192 which is illustrated in more detail in FIG. 12. FIG. 12 is a view in section along line 12-12 of FIG. 7 showing the profile from center along the middle portion of tab 192. Dome 161 extends outwardly to flute 180 which extends downwardly to an upper step 206. Step 206 extends outwardly from center to a downward projecting sidewall portion 208 which, in turn, transitions to a lower step 210. The outer portion 212 of the tab extends further downwardly as shown in FIG. 12. Tab 192 thus defines an upwardly extending cavity 214 where a user can insert a finger or thumb to remove lid 160 from a plate, platter or bowl. The relative position of the cavity is illustrated with respect to undercut groove 194 and including undercut 196 in the diagram in phantom lines. It can be seen that cavity 214 extends upwardly with respect to engagement perimeter 184. In the embodiment of FIG. 7 and following, sidewall 164 extends downwardly in a substantially linear, continuous manner from upper surface portion 162 to engagement perimeter 184 as is illustrated in FIGS. 9 through 12 in particular. It is likewise possible to have a “stepped” profile as is shown schematically in FIG. 13.

In FIG. 13 there is shown a profile of a lid 216 having a generally planar dome portion 218 and a fluted sidewall 220. Fluted sidewall 220 extends downwardly to a step 222 which extends outwardly to a corner 224. Unfluted sidewall 225 extends downwardly to an engagement portion 226 including an undercut groove 228 which, in turn, transitions to an outermost portion 230. The step height is the distance between corner 224 and engagement portion 226.

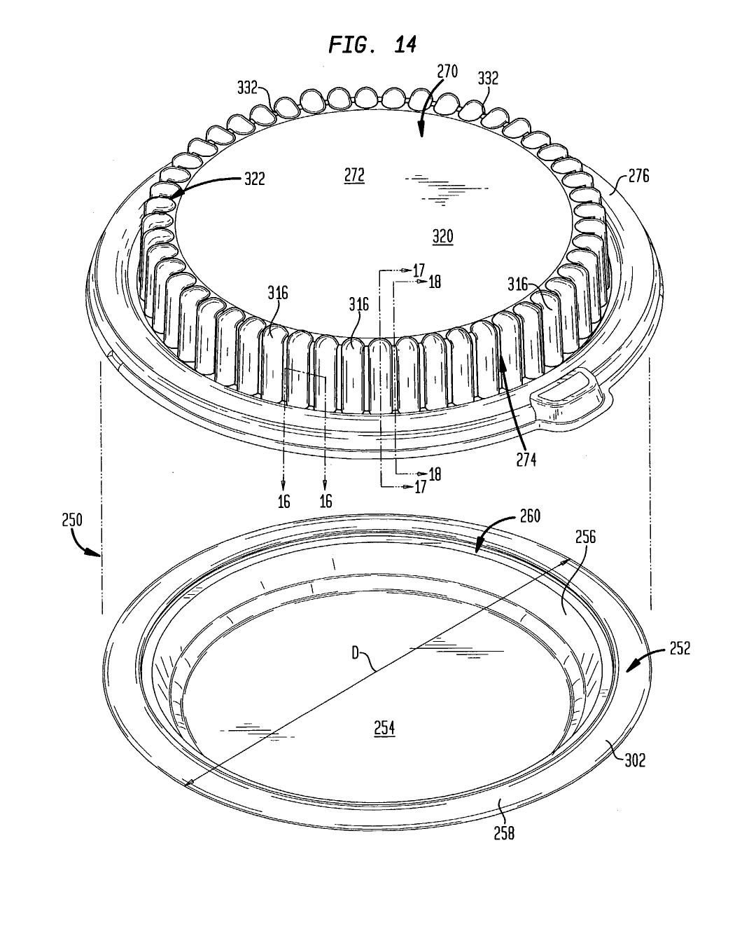

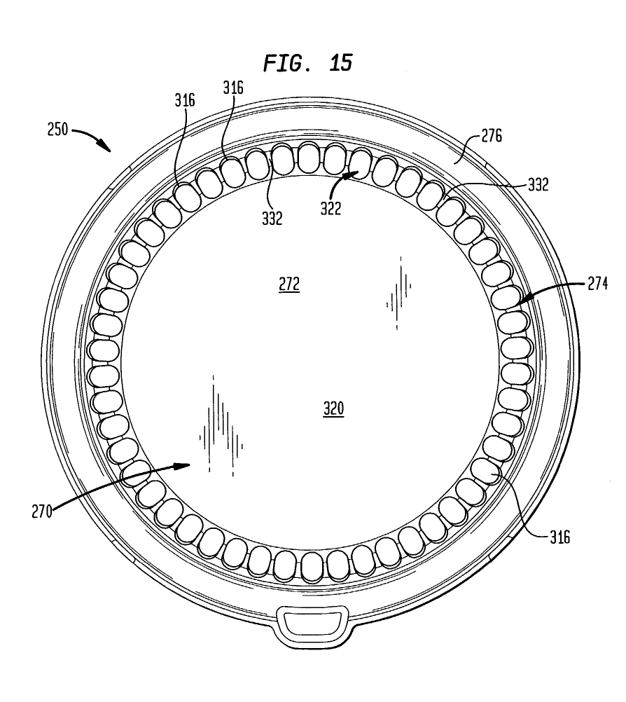

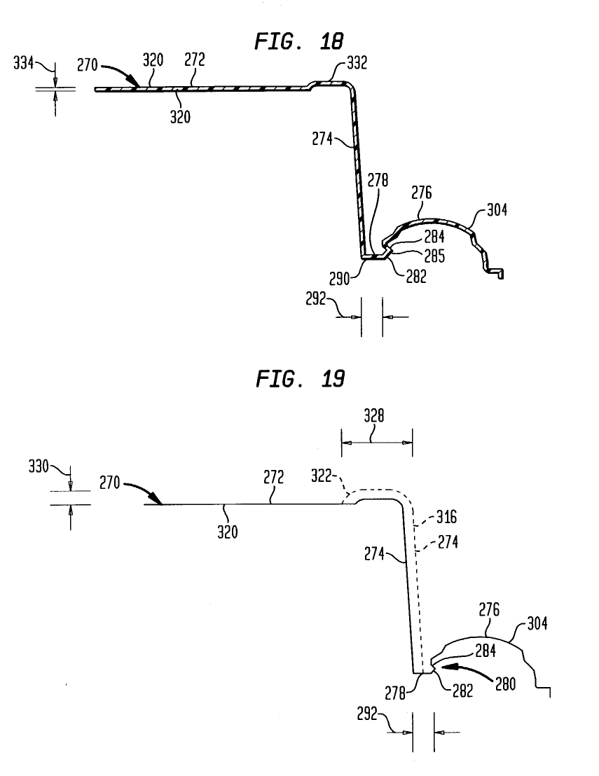

Referring to FIGS. 14-21 there is shown a sealable food container 250 including a plate 252 having a generally planar central portion 254, a plate sidewall 256 extending generally upwardly and outwardly therefrom and a plate outer flange portion 258 extending outwardly from the sidewall. The planar central portion or bottom 254 of the plate may be provided with a slight crown if so desired as is known in the art to prevent rocking when the container is placed on a flat surface. The plate is generally circular with a characteristic diameter, D which may be, for example, about 10¼ inches and have a circumference around its sealing area of between 25 and 30 inches or so; that is, the diameter of the stop ridge about its lower edge in the sidewall may be about 8⅝ inches for a plate with a characteristic diameter of 10¼ inches.

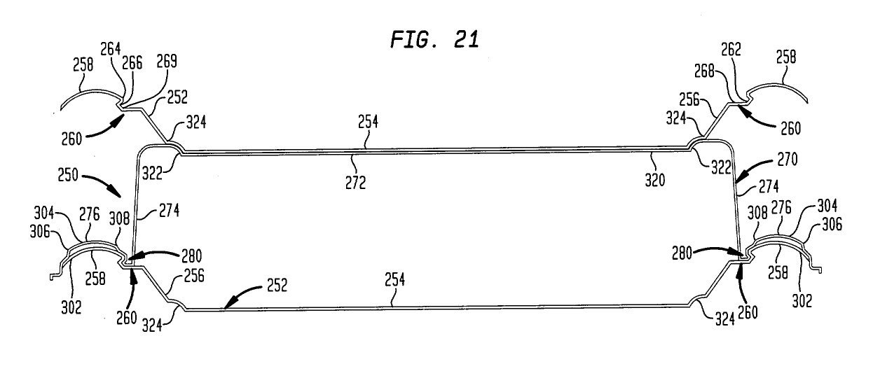

In FIGS. 20 and 21, sidewall 256 defines a sealing portion 260 with an undercut annular sealing surface 262 disposed between the substantially planar central portion 254 of plate 252 and the plate outer flange portion 258. Sidewall sealing portion 260 defines a base stop ridge 264 at the upper edge 266 of the undercut annular sealing surface 262 of the sidewall. There is further defined by the sidewall a laterally extending retaining shelf 268 adjacent to undercut annular sealing surface 262. Shelf 268 is generally horizontal (parallel to planar portion 254) and located adjacent lower edge 269 of annular plate sealing surface 262 as shown. Shelf 268 has a shelf length 271 over the generally horizontal span between edge 269 of surface 262 and an inner edge 267 of shelf 268.

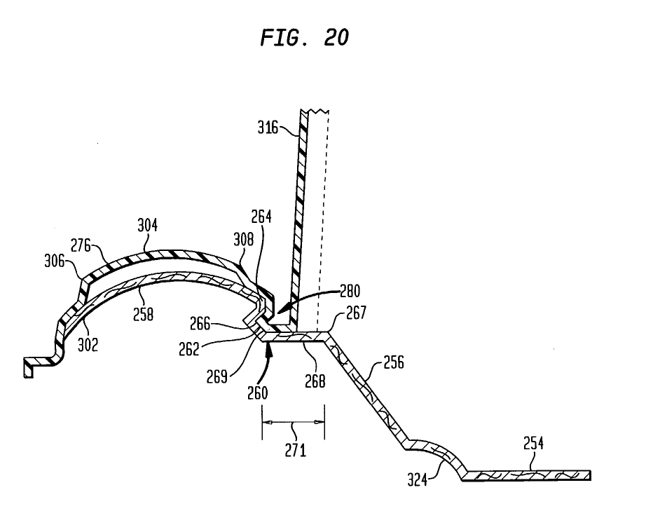

Container 250 also includes a sealing lid 270 provided with a lid dome portion 272, a flexible lid sidewall 274 extending downwardly from dome portion 272. Both the flat portion of sidewall 274 and fluted portion of sidewall 274 are shown in FIG. 19. The lid also has a lid flange portion 276 extending outwardly with respect to the downwardly extending lid sidewall. The lid flange portion includes at its inner periphery 278 a lid sealing portion 280. Lid sealing portion 280 defines a frustal sealing surface 282 extending upwardly and outwardly with respect to the downwardly extending sidewall of the sealing lid. Lid sealing portion 280 also defines a lid stop ridge 284, generally adjacent an upper edge 285 of surface 282. The plate and the sealing lid are configured such that when the sealing lid is forced downwardly on plate 252 sealing lid 270 is secured to the base serving member by cooperation of base stop ridge 264 and lid stop ridge 284.

Laterally extending retaining shelf 268 of plate 252 extends outwardly over a base shelf length 271 which is generally at least about 0.5% of the characteristic diameter D of plate 252. The characteristic diameter of the container is taken as the diameter, for example, of the base serving member in the case of a round plate as shown. With respect to other shapes that may be employed in accordance with the present invention, the characteristic diameter of the base serving member such as a plate or platter is taken as the average dimension across the base, for example, for a rectangular or polygonal shape, one simply would take a mean span across the article from one outer edge to its opposite outer edge across the middle of the article.

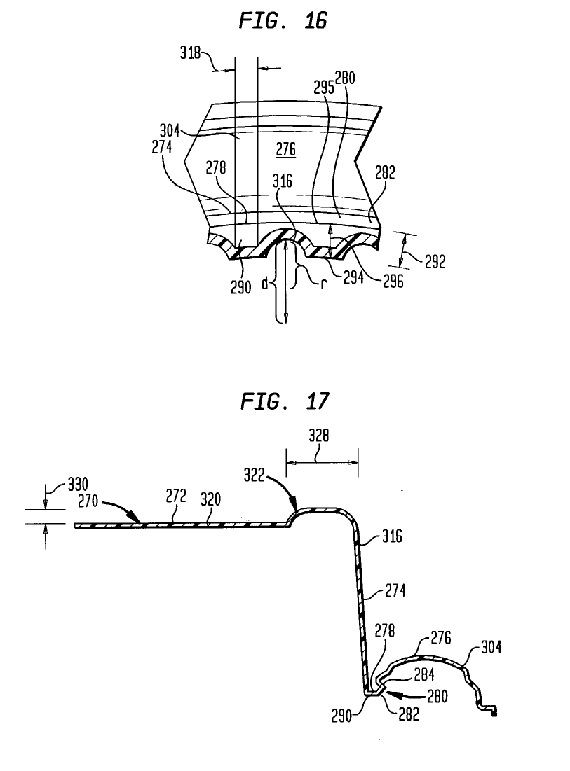

Referring in particular to FIGS. 16 and 18-19, the sealing lid is preferably provided with a laterally extending lid shelf 290 extending between flexible sidewall 274 of the sealing lid and the frustal sealing surface 282 of lid 270. Lid shelf 290 extends outwardly over a lid shelf radial span 292 and is adapted to cooperate with the retaining shelf of plate 252 to position the sealing lid with respect to the base. It should be noted as used herein, the term “lid shelf radial span” refers to maximum span 292 from an inner edge 294 of the shelf to an outer edge 295 of lid shelf 290 such that in the case of a lid stop shelf that has a fluted or scalloped inner edge, the lid stop shelf radial span 292 is the maximum distance between inner edge 294 of the lid stop shelf and the upwardly and outwardly extending frustal sealing surface 282 of sealing portion 280, as is shown at 296, for example. As noted above, the length of the lid shelf radial span is typically at least about 25% of base sidewall shelf length 271. Preferably the lid shelf radial span is greater than that.

In preferred embodiments, undercut sealing surface 262 of plate 252 is a frustal sealing surface extending upwardly and outwardly with respect to substantially planar central portion 254 of plate 252. Annular sealing portion 280 of sealing lid 270 also preferably includes a frustal configuration of sealing surface 282 extending upwardly and outwardly with respect to the downwardly extending sidewall of sealing lid 270.

Preferably base stop ridge 264 is located adjacent the upper edge of sealing surface 262 of sidewall 256 of plate 252; whereas lid stop ridge 284 is located adjacent the upper edge of sealing surface 282 of the lid. The lid is dimensioned so as to outwardly flexibly urge its frustal sealing surface 282 into surface to surface contact with frustal sealing surface 262 of plate 252 (also in a frustal configuration) when plate and sealing lid 270 are secured to one another.

Both the base serving member, typically a plate, and sealing lid may be provided with an arcuate outer flange. Outer arcuate flange 302 of plate 252 is generally arcuate in shape typically having a radius of curvature which is more or less constant. On the other hand, arcuate outer flange 304 of sealing lid 270 may have a plurality of ridges such as ridges 306 and 308 in its profile if so desired. In any case, sealing lid outer flange 304 is generally configured to overlay arcuate outer flange 302 of the plate as shown particularly in FIGS. 20 and 21.

Flexible sidewall 274 of sealing lid 270 is provided with a plurality of outwardly convex flutes 316 formed in the sidewall. Typically lid 270 includes about 3 or fewer flutes per inch of engagement perimeter, that is the circumferential length about the lower edge of base stop ridge 264 which is also approximately the circumferential distance about upper edge 285 of annular surface 282.

As shown in FIG. 16, flutes 316 have a characteristic cylindrical diameter, d, which is twice the radius of curvature, r, of the inner surface of the sidewall. As noted above this diameter is typically less than about 0.75 inches.

As will be appreciated from the Figures the outwardly convex flutes are typically circumferentially spaced apart from one another. The outwardly convex flutes are spaced apart a distance 318 (FIG. 16) generally from about 0.05 to about 0.25 inches about the periphery of the lid. So also, the convex flutes project upwardly with respect to generally planar upper surface portion 320 of dome 272 of the sealing lid and define a generally upwardly convex and generally inwardly retaining ridge upper profile 322 as can be seen in the various Figures.

Plate 252 is provided with an annular sidewall stacking recess 324 adjacent generally planar bottom portion 254 at the lower portion of sidewall 256. Recess 324 is adapted to engage generally convex retaining ridge profile 322 of the sealing lid in order to render a plurality of sealable food containers securely stackable with one another as is seen best in FIG. 21.

Typically the upwardly convex retaining ridge profile adjacent the upper, generally planar portion 320 of the sealing lid comprises a plurality of spaced arcuate flute profiles 316 extending inwardly from the outer periphery of the container. The inward extension length 328 (FIGS. 17, 19) of the flutes inwardly adjacent planar portion 320 of dome 272 may be of any suitable length; but typically at least about 0.2 and preferably at least about 0.3 inches in preferred embodiments.

The flutes may have a flute height 330 above generally planar upper surface 320 of dome 272 of greater than about 0.075 inches. In the embodiments shown, there are provided a plurality of flat portions 332 between the upwardly extending flutes 316 having a flat portion height 334 of generally greater than about 0.01 inches. The relative profiles of the flutes and flat portions there between are perhaps best appreciated by reference to FIGS. 17 through 19.

It should be appreciated by reference to FIG. 16, that lid shelf 290 of lid 270 is typically a fluted lid shelf. Radial span 292 is indicated on FIG. 16 as noted above.

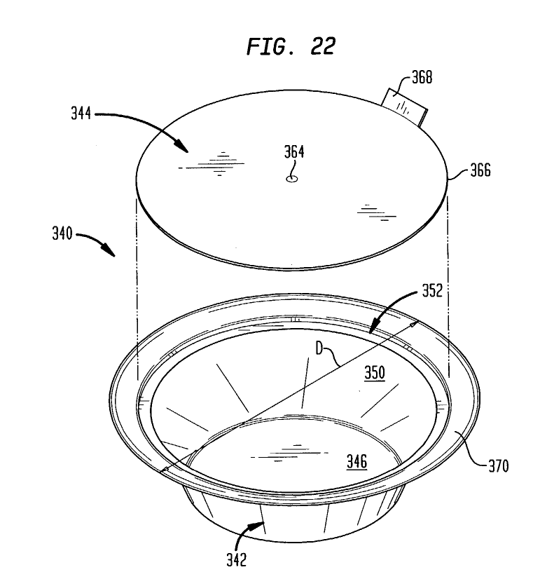

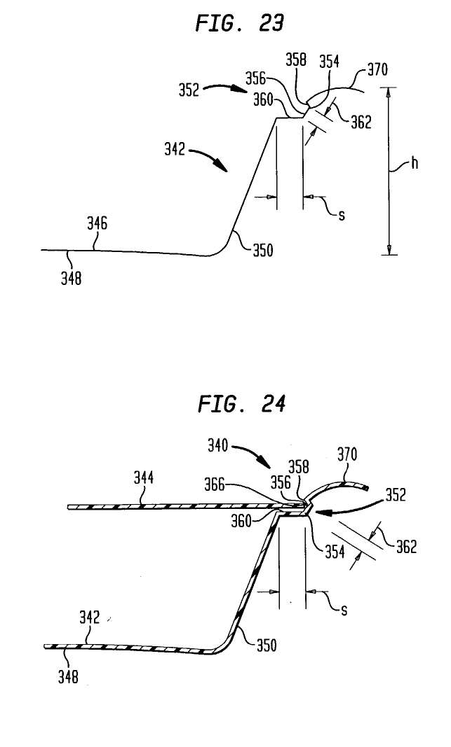

There is illustrated in FIGS. 22-24 another container which may be used in connection with the assembly of the present invention.

Container 340 includes generally a thermoformed base such as bowl 342 and a lid, such as planar paperboard lid 344. Bowl 342 includes a generally planar base central portion 346 which may have a slight crown indicated at 348 if so desired. The planar central portion transitions to a sidewall 350 which defines a sealing region 352. There is provided as part of the sealing region an annular sealing portion 354 preferably including a frustoconical surface 356 adjacent a stop ridge 358 at the upper extremity of the sealing portion.

The sealing region further includes a laterally extending retaining shelf 360 adjacent the lower edge of the sealing portion.

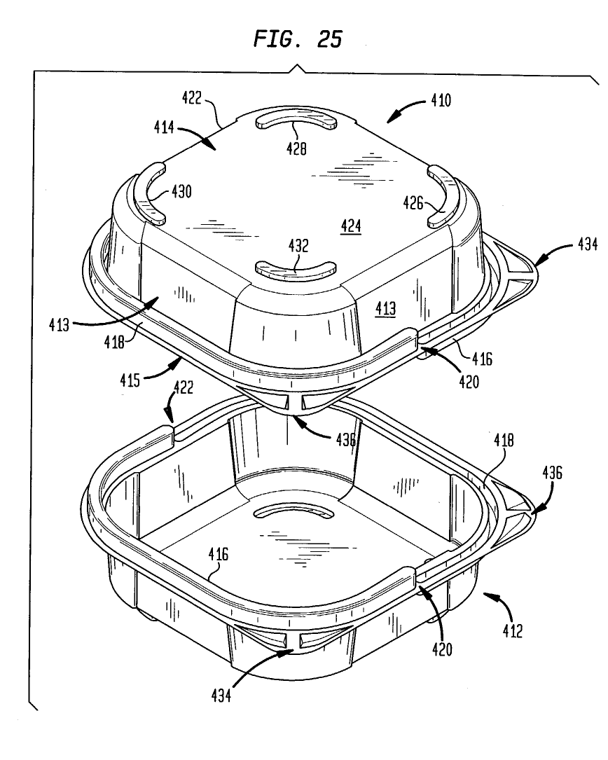

It will be appreciated from the diagrams that the sealing portion is most preferably in the form of an undercut sidewall groove configured to secure paperboard lid 344 as shown schematically in FIG. 24.

The bowl may have a diameter, D, of 6¼″ or so and a height, h, of about 1¾″ if so desired. The laterally extending shelf has a shelf width, s, is typically about ⅛″, such that the ratio h:s is less than about 20, typically less than about 15 and less than 10 for containers wherein the base is a plate, for example. Frustoconical surface 356 typically extends upwardly and outwardly a distance 362 which is less than distance, s, typically about ½ s or so.

Paperboard lid 344 is provided with a hole 364 generally centrally located in the lid as shown in FIG. 22. Hole 364 acts as a vent for steam when the contents of the container are heated. The paperboard lid is configured such that its periphery 366 engages frustoconical surface 356 and may include a tab 368 so that the lid is easily removed. That is, one could simply grasp the outer arcuate flange 370 of bowl 342 and pull on tab 368 to disengage the lid from the container. When surface 356 extends over a distance 362 of 1/16″ or thereabouts, paperboard lid 344 may have a caliper of 10-40 mils or so.

Shelf 360 extends over a substantial distance, s, so it retains lid 344; that is to say, bowl 342 is placed on a flat surface and lid 344 is pressed downwardly so that it is positioned by shelf 360 and prevented from continuing downwardly. When thus engaged to bowl 342, stop ridge 358 secures the lid in position as shown in FIG. 24.

Still yet another embodiment of the inventive packaging system includes a stack of containers formed from the container halves illustrated in FIGS. 25-30.

Referring to the Figures, there is shown in FIG. 25 an exploded view of two mating container parts showing a first container part 410 and a second container part 412. Throughout this description of the Figures, it should be understood that in the illustrated embodiments the materials are translucent, thus many lines are illustrated as solid lines which would be hidden lines in opaque embodiments. Each container (or container part, the terminology being equivalent for present purposes) has a dome portion 414 which includes a sidewall 413 which transitions to a rim 415. The rim of each container has a male ridge section 416 as well as a female groove section 418 which are separated on each container by transition sections 420 and 422. The dome has a flat portion 424 as well as a plurality of stacking ridges 426, 428, 430, and 432.

The rim is also provided with two separator tabs 434, 436, at two adjacent corners of the containers.

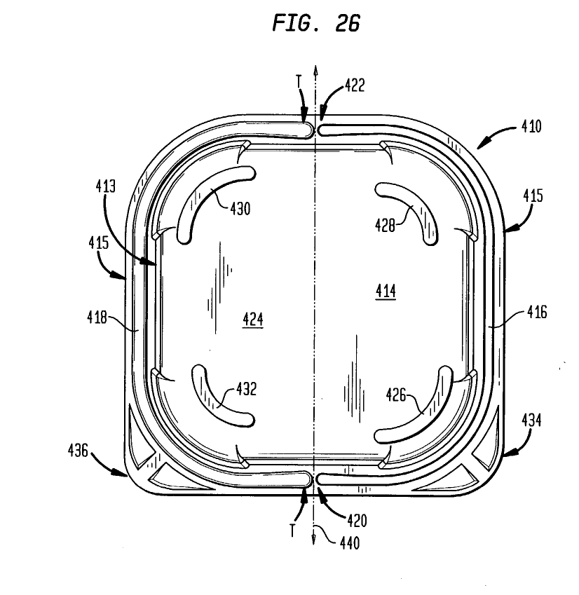

Referring now to FIG. 26, the interlockable rim structures of the containers are, generally speaking, symmetrical about an axis of rotation 440 such that, when a container, is rotated or inverted, it will mate with a like container to form a sealed enclosure. That is to say the inventive containers can function as both the lid and the base of a container as is shown. It should be noted that the tabs 434, 436 project outwardly from the sealing grooves and ridges further than any other areas of the rim. So also, generally speaking the interlockable rim structure including the male ridge sections, the female groove sections as well as the transition sections are generally formed about a rim plane 438 which is generally at the base of the ridges and the top of the female groove sections as is shown schematically in FIG. 28.

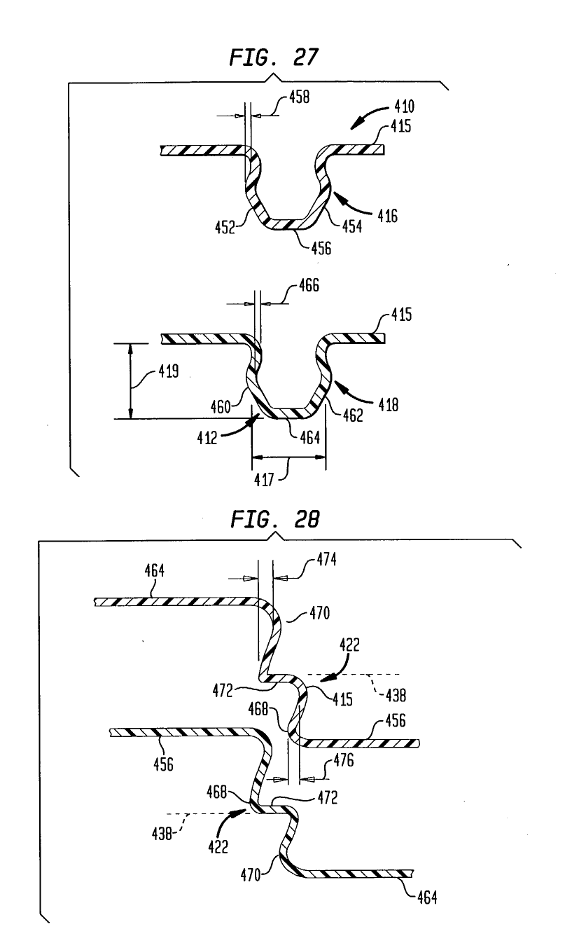

Referring to FIGS. 27 and 28 there is shown in partial section and elevation an exploded view of the rim details of inventive container parts 410 and 412 in position for forming a sealed container but still separated from each other. It can be seen that the various rim sections such as section 416, 418 and as well as transitions sections such as section 422 will cooperate when inverted to form complimentary structures which will seal a pair of containers to one another. More specifically there is shown schematically in FIG. 27 an enlarged detail showing male ridge section 416 of container 410 and female groove section 418 of container 412. Male ridge section 416 is generally U-shaped as shown in the diagram and includes a first sidewall 452 as well as a second sidewall 454 and a generally planar medial portion at the top of the ridge indicated at 456. The sidewalls are undercut a distance 458 as shown in the diagram. Likewise, female groove section 418 has a first side wall 460 and a second sidewall 462 as well as a generally planar medial portion 464. The sidewalls are undercut a distance 466 such that they will cooperate with the male sealing portions on a like container part (or container, it being understood these terms are used interchangeably) when two are joined together to form a generally liquid proof seal. Most preferably, the medial portions are urged into surface to surface contact to further seal the container.

There is shown in FIG. 28 an enlarged schematic view illustrating schematically the geometry of transition sections 422 as they are placed adjacent each other preparatory to engagement as is shown in the diagram. Each transition section 422 includes a generally vertical or vertically extending male arculate undercut wall 468 as well as a generally vertical or vertically extending female arculate undercut wall 470 with a transition ledge 472 there between, the respective male and female vertical extending walls are undercut a distance 476 and 474 respectively in order to urge the various transition portions into engagement with a like transition portion on an inverted like.

Note that the various parts are configured to cooperate to form a substantially liquid proof seal; it being understood that the seals formed at the transition regions are not quite as effective as those formed in the groove and ridge regions and thus are described as being in “virtually sealing engagement” in these areas in particular when containers are joined together.

Male ridge section 416 is urged into surface to surface contact with female groove section 418, that is to say male ridge section 416 of container 410 is urged downwardly and into contact with female groove section 418 of container 412. The medial portions of the female groove section and male ridge section are urged into surface to surface contact between the sidewalls by virtue of their configuration when the two containers are snapped together such that their grooves respective undercuts cooperate to hold them together.

Likewise, the transition sections 420 and 422 of the various containers are urged into surface to surface contact particularly at opposed portions on either side of the transition ledge between the female undercut vertically extending walls and male undercut vertical vertically extending walls. Thus there is provided a container with both radially undercut grooves and ridges and arculate undercut transition sections which urge the sealing surfaces into contact around the entire periphery of the container. That is to say, the grooves are undercut in a direction extending generally inwardly or outwardly from center while the transition sections are undercut around the arcules at the end of the respective grooves and ridges. Thus the containers will form a substantially continuous seal around the periphery of each other when placed into engagement with one another to form an enclosure. It being understood that the seal, while highly effective, especially when viewed in light of the low cost nature of the articles, is of course less than perfect, particularly at the transition regions where the seal formed might allow a few drops of moisture to penetrate when a pair of containers holding partially filled with water is shaken with the transition region lowermost; but compression, effort and/or agitation is required to remove more than a few drops of liquid from the joined containers.

The inventive containers are in preferred embodiments thermoformed containers. As can be seen from the various diagrams, the draw ratio of the dome portion of the containers is typically fairly low, much less than 1 in most cases; however the draw ratio of grooves 418 and ridges 416 is much higher. In general, the draw ratio of a thermoformed article or a portion thereof is the ratio of the depth of an opening divided by its width. As used herein, the terminology is adapted to the configuration of grooves 418, ridges 416 and transition sections 420, 422 as follows: (a) the “sealing rim draw ratio” is the depth 419 of the groove divided by the width 417 of the groove as shown in FIG. 27 taken as an average around the sealing rim of the container; and (b) the “transition draw ratio” is the sealing rim draw ratio in the vicinity of transitions 420, 422, at T shown in FIG. 26, immediately adjacent the curved profile of the transition where the width of the groove is at a local maximum near the transition. The grooves are widened at the transitions in the embodiments shown to reduce the draw ratio at the transition and avoid too much thinning of the container material in these regions. While some degree of thinning may enhance the configuration and performance of the undercuts, excess thinning can lead to product failure and is to be avoided in corner areas of the thermoformed article such as the transition areas. So also, note the arculate profile of the sealing surfaces of the transition sections. They are convex away from the ridge and concave toward the groove as shown. Sharp corners are thus avoided.

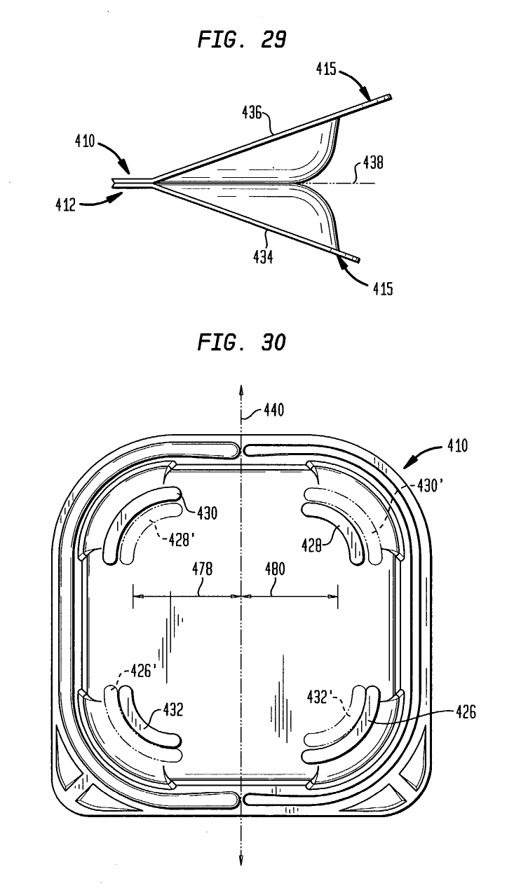

FIG. 29 is a schematic view of the geometry and results achieved by way of the inventive separator tabs such as tabs 434 and 436 when two of the inventive containers are joined. Because it has an inclined surface, the tab will force the rim sections 415 to assume an angle as is shown in FIG. 29 such that they are readily separated from one another despite the fact that the containers are tightly joined together. It should also be appreciated that by virtue of the unique geometry of the stacking ridges, the stacking ridges on two like containers will cooperate to provide stability to a stack of joined containers as is shown schematically in FIG. 30.

In FIG. 30 there is shown the top of container 410 with the various stacking ridges 426, 428, 430 and 432 shown in solid lines. It will be appreciated that these stacking features are asymmetric about axis of rotation 440 in several respects. It should be appreciated from the diagram that opposed pairs of stacking ridges are at different distances 478 and 480 from axis of rotation 440. That is, the center of arcuate ridge 428 is substantially closer to axis 440 than the center of ridge 430. So also, the center of ridge 432 is closer to the axis of rotation than is the center of ridge 426. Thus, when an identical container is inverted or rotated 180° about the axis of rotation the complimentary complementary position of the various ridges is shown by the dotted lines indicating ridges 426′, 432′, 430′ and 428′ in the diagram such that the stacking ridges are interlockable and prevent stacked containers from sliding in any direction. Such geometry could of course be realized by providing non-arcuate stacking ridges with the required asymmetric configuration. Generally speaking this configuration requires that when the stacking ridges are rotated 1800 they will interlock with complementary ridges on a like container so that the bottom of one container will stack in interlockable relationship with the lid of another container as will be appreciated from FIG. 30.

The containers of FIGS. 25-30 are stacked as shown schematically in FIG. 30 and placed in the packaging system of FIG. 1 in place of, or in addition to, the type of containers shown in FIG. 1, as well as those shown in FIGS. 7 and following.

While the invention has been described in detail, various modifications to the specific embodiment illustrated will be readily apparent to those of skill in the art. For example, one could produce a container with additional features such as additional ridges and so forth. Such modifications are within the spirit and scope of the present invention defined in the appended claims.

What is claimed is:

1. A packaging system assembly for carry-out food comprising:
(a) a plurality of sealable and stackable disposable containers each of which includes a lid and a base, said lid including ridge means about its upper portion adapted to receive the bottom portion base of a like container and maintain the like container in aligned stacked relationship thereto when the containers are stacked, each of the plurality of containers being characterized by a common outer container perimeter;
(b) a multilayer, liquid-impervious composite carry-out bag which is substantially water vapor and liquid-impervious provided with an apertured handle and at least front, and back and bottom panels, said carry-out bag further including a mechanical interlock for securing the front panel thereof to the rear panel thereof in generally liquid and water vapor impermeable relationship, and said bottom panel being substantially congruent in shape to said sealable and stackable disposable containers and being characterized by an internal perimeter sized to accommodate a stack of the plurality of sealable containers having the common outer container perimeter to form said packaging system assembly and maintain the stack in alignment during transport thereof, said assembly being configured to maintain said disposable containers horizontally while suspended from its apertured handle; being capable of being stably disposed on a horizontal flat surface while suspended from said apertured handle while maintaining said disposable containers horizontally and being removed from said horizontal flat surface by said apertured handle while maintaining said disposable containers horizontally.

2. The packaging system assembly according to claim 1, wherein said carry-out bag is provided with a generally flat bottom panel.

3. The packaging system assembly according to claim 2, wherein the generally flat bottom panel has an aspect ratio of about 1.4 or less.

4. The packaging system assembly according to claim 2, wherein the generally flat bottom panel has an aspect ratio of about 1.3 or less.

5. The packaging system assembly according to claim 2, wherein the front panel of the carry-out bag is joined directly to the rear panel of the carry-out bag.

6. The packaging system assembly according to claim 5, wherein the front panel of the carry-out bag is melt-bonded to the rear panel of the carry-out bag.

7. The packaging system assembly according to claim 1, wherein said carry-out bag includes as one layer a metallized polymer film.

8. The packaging system assembly according to claim 7, wherein said carry-out bag includes as one layer a paper layer.

9. The packaging system assembly according to claim 8, wherein said carry-out bag is formed from a laminated composite material incorporating a metallized polymer film, a second polymer film laminated thereto and a paper layer which is likewise laminated to the second polymer film.

10. The packaging system assembly according to claim 8, wherein the paper layer of the carry-out bag is pattern laminated to the metallized polymer film, optionally including one or more intermediate polymer layers.

11. The packaging system assembly according to claim 1, wherein said apertured handle of the carry-out bag is die-cut into the front and back panels of the carry-out bag.

12. The packaging system assembly according to claim 11, wherein the die-cut handle is configured such that the panel material is cut over less than a complete handle aperture perimeter whereby the material of the panels may be folded through the handle aperture to provide a mechanical interlock in order to secure the front panel to the rear panel.

13. The packaging system assembly according to claim 11, wherein said die-cut apertured handle has an arched upper grip.

14. The packaging system assembly according to claim 1, wherein said carry-out bag is adapted to reliably transport a load of at least about 3 lbs.

15. The packaging system assembly according to claim 1, wherein said carry-out bag is adapted to reliably transport a load of at least about 5 lbs.

16. The packaging system assembly according to claim 1, wherein said carry-out bag is adapted to reliably transport a load of at least about 7 lbs.

17. The packaging system assembly according to claim 1, wherein said apertured handle of the carry-out bag has an Instron® failure value of at least about 20 lbs.

18. The packaging system assembly according to claim 1, wherein said apertured handle of the carry-out bag has an Instron® failure value of at least about 30 lbs.

19. The packaging system assembly according to claim 18, wherein said apertured handle of the carry-out bag has an Instron® failure value of at least about 40 lbs.

20. The packaging system assembly according to claim 1, wherein said carry-out bag is formed of a self-supporting material.

21. The packaging system assembly according to claim 20, wherein said compact bag is configured to maintain the apertured handle in an erect position when the assembly is placed on a flat surface.

22. The packaging system assembly according to claim 1, wherein the front and back panels of the carry-out bag are provided with mating interior closure elements about their upper portions in the interior of the carry-out bag to secure the front panel of the carry-out bag to the back panel of the carry-out bag upon application of pressure to the closure elements.

23. The packaging system assembly according to claim 22, wherein the mating closure elements include a first continuous closure element extending substantially entirely across the interior of the front panel of the carry-out bag and a second continuous closure element extending substantially entirely across the interior of the entire back panel of the carry-out bag which are adapted to form a substantially liquid-proof and vapor-proof seal upon application of pressure to the closure elements so as to seal the interior of the carry-out bag.

24. The packaging system assembly according to claim 23, wherein said first and second continuous closure elements comprise male and female closure elements arranged to be interlocked over their length.

25. The packaging assembly system according to claim 1, wherein the internal perimeter of the carry-out bag is from about 5 to about 30 percent larger than the common outer container perimeter of the plurality of sealable disposable containers.

26. The packaging system assembly according to claim 25, wherein the internal perimeter of the carry-out bag is from about 7.5 to about 25 percent larger than the common outer container perimeter of the plurality of sealable disposable containers.

27. The packaging system assembly according to claim 26, wherein the internal perimeter of the carry-out bag is from about 10 to about 20 percent larger than the common outer container perimeter of the plurality of sealable disposable containers.

28. The packaging system assembly according to claim 25, wherein the front panel of the carry-out bag is joined directly to the rear panel of the carry-out bag.

29. The packaging system assembly according to claim 1, wherein the composite bag is provided with a fibrous reinforcing panel adhered to the bag about the apertured handle.

30. The packaging system assembly according to claim 1, wherein the fibrous aperture reinforcing panel extends over a distance of from about ¼ inch to about 2 inches outwardly from the apertured handle perimeter.

31. The packaging system assembly according to claim 30, wherein the fibrous aperture reinforcing panel extends over a distance of from about ½ inch to about 1½ inches outwardly from the apertured handle perimeter.

32. The packaging system assembly according to claim 1, wherein the fibrous aperture reinforcing panel is a nonwoven fiber reinforcing panel.

33. The packaging system assembly according to claim 32, wherein the fibrous reinforcing panel is a spunbond polyethylene fiber reinforcing panel.

34. The packaging system assembly according to claim 1, wherein the front and back panels of the composite bag are each provided with fibrous aperture reinforcing panels adhered thereto about the apertured handle perimeter.

35. A packaging system assembly for carry-out food comprising:
(a) a plurality of scalable and stackable disposable containers each of which includes a lid and a base and defines a retaining ridge about its upper portion adapted to receive the bottom of a like container and maintain the like container in aligned stacked relationship thereto when the containers are stacked, each of the plurality of containers being characterized by a common outer container perimeter, wherein the lids include domes having generally planar upper portions and downwardly extending sidewalls provided with a plurality of outwardly convex flutes formed in said sidewalls, said flutes having characteristic cylindrical diameters, said sidewalls extending downwardly to an engagement portion of said lids adapted to be secured to the bases about engagement perimeters of said lids, wherein said lids include about 1.85 or fewer flutes per inch of engagement perimeter; and
(b) a multilayer, liquid-impervious composite carry-out bag provided with an apertured handle and at least front and back panels, said carry-out bag further including a mechanical interlock for securing the front panel thereof to the rear panel thereof and being characterized by an internal perimeter sized to accommodate a stack of the plurality of sealable containers having the common outer container perimeter and maintain the stack in alignment during transport thereof, said assembly being configured to maintain said disposable containers horizontally while suspended from its apertured handle; being capable of being stably disposed on a horizontal flat surface while suspended from said apertured handle while maintaining said disposable containers horizontally and being removed from said horizontal flat surface by said apertured handle while maintaining said disposable containers horizontally.

36. The packaging system assembly according to claim 35, wherein said lids include from about 1.5 to about 1.85 flutes per inch of engagement perimeter.

37. The packaging system assembly according to claim 35, wherein the ratio of the characteristic cylindrical diameter of said flutes to the engagement perimeter of said lids is from about 0.0125 to about 0.025.

38. The packaging system assembly according to claim 35, wherein said lids are thermoformed, thermoformed by the application of vacuum or thermoformed by a combination of vacuum and pressure from a sheet of thermoplastic material.

39. The packaging system assembly according to claim 38, wherein said lids have a wall caliper of from about 8 to about 20 mils.

40. The packaging system assembly according to claim 39, wherein said lids have a wall caliper of from about 8 to about 15 mils.

41. The packaging system assembly according to claim 40, wherein said lids have a wall caliper of from about 10 to about 13 mils.

42. The packaging system assembly according to claim 38, wherein said lids are thermoformed by the application of vacuum.

43. The packaging system assembly according to claim 38, wherein said lids are thermoformed from oriented polystyrene sheet.

44. The packaging system assembly according to claim 38, wherein said lids are thermoformed from a sheet of thermoplastic material comprising polypropylene.

45. A packaging system assembly for carry-out food comprising:
(a) a plurality of sealable and stackable disposable containers each of which includes a lid and a base and defines a retaining ridge about its upper portion adapted to receive the bottom of a like container and maintain the like container in aligned stacked relationship thereto when the containers are stacked, each of the plurality of containers being characterized by a common outer container perimeter, wherein the containers comprise:
(i) base serving members having generally planar base central portions, base sidewalls extending generally upwardly and outwardly therefrom and base outer flange portions extending outwardly from said base sidewalls;
(ii) said base sidewalls defining base sealing regions with (i) annular base sealing portions disposed between said substantially planar base central portions of said base serving members and said base outer flange portions, (ii) base stop ridges adjacent upper extremities of said annular base sealing portions as well as (iii) laterally extending retaining shelves adjacent lower extremities of said annular base sealing portions; and
(iii) sealing lids provided with peripheral portions adapted to be retained by the annular base sealing regions of the base serving members,
wherein said base serving members and the said sealing lids are configured such that when a sealing lid is forced downwardly on a base serving member, the lid is positioned by the retaining shelf and secured to the base serving member by the base stop ridge; and
(b) a multilayer, liquid-impervious composite carry-out bag provided with an apertured handle and at least front and back panels, said carry-out bag further including a mechanical interlock for securing the front panel thereof to the rear panel thereof and being characterized by an internal perimeter sized to accommodate a stack of the plurality of sealable containers having the common outer container perimeter and maintain the stack in alignment during transport thereof, said assembly being configured to maintain said disposable containers horizontally while suspended from its apertured handle; being capable of being stably disposed on a horizontal flat surface while suspended from said apertured handle while maintaining said disposable containers horizontally and being removed from said horizontal flat surface by said apertured handle while maintaining said disposable containers horizontally.

46. The packaging system assembly according to claim 45, wherein said lids are domed lids.

47. The packaging system assembly according to claim 45, wherein the annular base sealing portions are undercut grooves.

48. The packaging system assembly according to claim 45, wherein the lids are generally planar and the base outer portions project upwardly with respect to their sealing regions so as to define the retaining ridges of the containers.

49. The packaging system assembly according to claim 48, wherein said lids are paperboard lids.

50. The packaging system assembly according to claim 45, wherein the container bases are formed of a microwaveable thermoplastic material.

51. The packaging system assembly according to claim 45, wherein said laterally extending retaining shelves of said base serving members extend outwardly over base sidewall shelf lengths of at least about 0.5% of the characteristic diameter of said base serving member.

52. The packaging system assembly according to claim 51, wherein said laterally extending retaining shelves of said base serving members extend outwardly over base sidewall shelf lengths of at least about 1% of the characteristic diameter of said base serving member.

53. The packaging system assembly according to claim 52, wherein said laterally extending retaining shelves of said base serving members extend outwardly over base sidewall shelf lengths of at least about 1.5% of the characteristic diameter of said base serving member.

54. The packaging system assembly according to claim 45, wherein said container bases are provided with stacking recesses in their lower sidewalls adapted to cooperate with the retaining ridges defined by the containers in order to maintain the stack in alignment during transport thereof.

55. A packaging system assembly for carry-out food comprising:
(a) a plurality of sealable and stackable disposable containers each of which includes a lid and a base and the lid includes ridge means about its upper portion adapted to receive the bottom of a like container and maintain the like container in aligned stacked relationship thereto when the containers are stacked, each of the plurality of containers being characterized by a common outer container perimeter, wherein the bases are formed of a microwaveable material;
(b) a multilayer, liquid-impervious composite carry-out bag provided with and at least front and back panels, said carry-out bag further including a mechanical interlock for securing the front panel thereof to the rear panel thereof and being characterized by an internal perimeter sized to accommodate a stack of the plurality of sealable containers having the common outer container perimeter and maintain the stack in alignment during transport thereof.

56. The packaging system assembly according to claim 55, wherein a multilayer, liquid-impervious composite carry-out bag is substantially water vapor and liquid-impervious and further is provided with an apertured handle and at least front, and back and bottom panels, and said bottom panel being substantially congruent in shape to said sealable and stackable disposable containers and said assembly being configured to maintain said disposable containers horizontally while suspended from its apertured handle; being capable of being stably disposed on a horizontal flat surface while suspended from said apertured handle while maintaining said disposable containers horizontally and being removed from said horizontal flat surface by said apertured handle while maintaining said disposable containers horizontally.

57. The packaging system assembly according to claim 55, wherein the container bases comprise a microwaveable paper material.

58. The packaging system assembly according to claim 55, wherein the container bases are formed from a microwaveable thermoplastic material.

59. The packaging system assembly according to claim 58, wherein said microwaveable thermoplastic material comprises a foamed or solid polymeric material selected from the group consisting of: polyesters, polypropylenes, polyethylenes and copolymers and mixtures thereof.

60. The packaging system assembly according to claim 59, wherein said microwaveable material is selected from the group consisting of polypropylene, mineral-filled polypropylene, polyesters and mineral-filled polyesters.

61. The packaging system assembly according to claim 60, wherein said base serving members are thermoformed from mineral-filled polypropylene sheet.

62. The packaging system assembly according to claim 61, wherein said base serving members have a wall thickness from about 10 to about 80 mils and consist essentially of from about 40 to about 90 percent by weight of a polypropylene polymer, from about 10 to about 60 percent by weight of a mineral filler, from about 1 to about 15 percent by weight polyethylene, up to about 5 weight percent titanium dioxide and optionally including a basic organic or inorganic compound comprising the reaction product of an alkali metal or alkaline earth element with carbonates, phosphates, carboxylic acids as well as alkali metal and alkaline earth element oxides, hydroxides, or silicates and basic metal oxides, including mixtures of silicon dioxide with one or more of the following oxides: magnesium oxide, calcium oxide, barium oxide, and mixtures thereof.

63. The packaging system assembly according to claim 58, wherein said base serving members have a wall caliper of from about 10 to about 50 mils.

64. The packaging system assembly according to claim 63, wherein said base serving members have a wall caliper of from about 12 to about 25 mils.

65. The packaging system assembly according to claim 55, wherein said lids are thermoformed from polystyrene.

66. The packaging system assembly according to claim 55, wherein said lids are thermoformed from polypropylene.

67. A composite bag for use in connection with a plurality of sealable and stackable disposable containers each of which includes a lid and a base, the lids including ridge means about their upper portions adapted to receive the bottom portion of bases of like containers and maintain the like container in aligned stacked relationship thereto when the containers are stacked, each of the plurality of containers being characterized by a common outer container perimeter, the bag comprising a liquid-impervious composite multilayer construction which is substantially water vapor and liquid-impervious provided with an apertured handle having an apertured handle perimeter and at least front, and back and bottom panels, and said bottom panel being substantially congruent in shape to said sealable and stackable disposable containers and being characterized by an internal perimeter sized to accommodate a stack of the plurality of sealable containers having the common outer container perimeter to form a packaging system assembly and maintain the stack in alignment during transport thereof, said assembly being configured to maintain said disposable containers horizontally while suspended from its apertured handle; being capable of being stably disposed on a horizontal flat surface while suspended from said apertured handle while maintaining said disposable containers horizontally and being removed from said horizontal flat surface by said apertured handle while maintaining said disposable containers horizontally, wherein there is further provided a fibrous aperture reinforcing panel adhered to the bag about the apertured handle perimeter.

68. The composite bag according to claim 67, wherein the fibrous aperture reinforcing panel extends over a distance of from about ¼ inch to about 2 inches outwardly from the apertured handle perimeter.

69. The composite bag according to claim 68, wherein the fibrous aperture reinforcing panel extends over a distance of from about ½ inch to about 1½ inches outwardly from the apertured handle perimeter.

70. The composite bag according to claim 67, wherein the fibrous aperture reinforcing panel is a nonwoven fiber reinforcing panel.

71. The composite bag according to claim 70, wherein the fibrous reinforcing panel is a spunbond polyethylene fiber reinforcing panel.

72. The composite bag according to claim 67, wherein the front and back panels of the composite bag are each provided with fibrous aperture reinforcing panels adhered thereto about the apertured handle perimeter.

73. A packaging system assembly for carry-out food comprising:
(a) a plurality of sealable and stackable containers having a common perimeter formed from a pair of interchangeable container parts, each container part having a dome portion with a substantially planar central portion and a sidewall extending from the central portion of the dome and transitioning to a rim wherein the rim has an interlockable rim structure defined about the periphery of the container part in a rim plane, said interlockable rim structure having at least one radially undercut male ridge section and at least one radially undercut female groove section defined therein, as well as a pair of arculate undercut transition sections therebetween, said radially undercut male ridge and radially undercut female groove sections being configured such that the radially undercut male ridge and radially undercut female groove sections on a container part having a substantially identical interlockable rim structure will seal with interpenetrating resilient engagement about the periphery of said container part, the radial undercuts on said ridges and grooves being configured to urge the grooves and ridges on container parts having a substantially identical interlockable rim structure into sealing radial engagement and wherein the arculate undercut transition sections are configured such that the arculate undercut transition sections on a container part having a substantially identical rim structure will urge the transition sections into virtually sealing engagement when container parts with like rim structures are joined to form a closed container; and
(b) a multilayer, liquid impervious composite bag characterized by an internal perimeter sized to accommodate a stack of the plurality of sealable containers having the common perimeter and maintain the stack in alignment during the transport thereof.

74. The packaging system assembly according to claim 73, wherein the central portions of the dome of the container parts are provided with a plurality of asymmetrically disposed arcuate stacking ridges having generally the same curvature as the sidewall at the corners, and being asymmetrically offset across an axis of rotation so as to cooperate with like ridges on an inverted like container part to secure a plurality of containers in a stack thereof.

75. The packaging system assembly according to claim 73, wherein the central portions of the domes of the container parts are provided with a plurality of asymmetrically disposed stacking ridges at the peripheries of the central portions of the domes, the stacking ridges being asymmetrically disposed across an axis of rotation so as to cooperate with like ridges on an inverted like container part to secure a plurality of containers in a stack thereof.

76. The packaging system according to claim 73, wherein the interchangeable container parts are thermoformed container parts and wherein the arculate transition sections of the container parts are drawn at a transition draw ratio that is less than the sealing rim draw ratio.
